(19) United States
(12) Patent Application Publication
(10) Pub. No.: US 2002/0104096 A1
(43) Pub. Date: Aug. 1, 2002

(54) System and methods for providing web-based multimedia presentations

(76) Inventors: Allen Brett Cramer, Fort Lauderdale, FL (US); John Robert Meyers, Fort Lauderdale, FL (US)

Correspondence Address: BRINKLEY, MCNERNEY, MORGAN,, SOLOMON & TATUM, LLP, Suite 1900, 200 East Las Olas Boulevard, Fort Lauderdale, FL, 33301-2209, US

(21) Appl. No.: 09/905,196

(22) Filed: Jul. 13, 2001

Related U.S. Application Data
(60) Provisional application No. 60/219,393, filed on Jul. 19, 2000.

(51) Int. Cl. G06F 3/00; H04N 5/445; G06F 13/00; H04N 7/173

(52) U.S. Cl. 725/113; 725/109; 725/51

(57) ABSTRACT

Various features are provided for allowing content providers (typically web site operators) to provide customized, multimedia presentations to end users within web pages. One feature involves a web-based player architecture that provides multiple display screens, each of which may correspond to a different content type (e.g., video, menu, caption, logo, animation, etc.). Another feature involves the use of scripting commands embedded within the video file or other streamed content to control various display attributes of the screens and of the player. These display attributes preferably include the visibility states and positions of the screens, such that a video or other streamed content can switch content items into and out of display and/or move screens to new positions during playing of the streamed content.

### PRIORITY CLAIM

This application claims the benefit of U.S. Provisional Appl. No. 60/219,393, filed Jul. 19, 2000, the disclosure of which is hereby incorporated by reference.

### FIELD OF THE INVENTION

The present invention relates to a scripting language, and associated software methods and components, for allowing content providers to generate customized web-based multimedia presentations.

### SUMMARY OF THE INVENTION

The present invention provides various features for allowing content providers (typically web site operators) to provide customized, multimedia presentations to end users within web pages. One aspect of the invention involves a web-based player architecture that provides multiple display screens, each of which may correspond to a different content type (e.g., video, menu, caption, logo, animation, etc.). Each screen is implemented as a layer of the same web page, and can be switched into an out of view based on commands contained within a video file or stream. In addition, actions performed with respect to one screen cause specific events to occur in other screens (e.g., selection of a menu item within a menu screen causes a video to play in the video screen).

The screens can also preferably be positioned within the web page independently of one another—using a data file associated with the web page and/or commands embedded within the video file. Some or all of the display screens may occupy the same display area, such that one type of content may be superimposed over another (e.g., a menu displayed over a playing video), or such that one type of content may be immediately switched into view in place of another (e.g., a video following a user selection from a playlist).

Another aspect of the invention involves the use of scripting commands embedded within the video file or other streamed content to control various display attributes of the screens and of the player. These display attributes preferably include the visibility states and positions of the screens, such that a video or other streamed content can switch content items into and out of display and/or move screens to new positions during playing of the streamed content. Further, through such embedded commands, the video or other streamed content can preferably control the display of text and other non-streamed content within other screens in synchronization with the playing of the streamed content. The video or other streamed content may also contain a command for specifying a particular player “skin” to be used for a particular multimedia presentation.

Another aspect of the invention involves the provision of a “pause” command that may be embedded within the video file to cause the video to be paused at a desired location. This command may be used in conjunction with other scripting commands to create an interactive presentation. For example, a video may pause itself to allow a graphic or advertisement to load, and/or to force the user to make a selection. One specific application for this feature involves pausing a video to display a related advertisement such that the user must perform some action (e.g., select a play button) in order to resume playing of the video. Another specific application involves an interactive training video which pauses itself to allow a student to respond to a multiple-choice question. Pause commands may similarly be inserted within other types of content that is played sequentially, such as music files and animation files.

Another aspect of the invention involves the ability to play multiple videos of different formats (e.g., Windows Media, Real Player, QuickTime, etc.) within the same web page. This is preferably accomplished in-part by referencing the browser plug-ins for such video formats as text strings within the web page, and loading each plug-in when it is needed.

### DETAILED DESCRIPTION OF A PREFERRED EMBODIMENT

A commercial embodiment of the invention, referred to herein as the “MatrixPlayer” (or simply “Player”), will now be described with reference to the attached drawings and charts. This commercial embodiment is presented in order to illustrate the various inventive features, and thus should not be read in a limiting sense. The scope of the invention is defined only by the appended claims.

I. Terminology

The following terminology will be used throughout the description of the MatrixPlayer:

User—an individual using a computer and a web browser application, e.g. Microsoft Internet Explorer or Netscape Navigator, to view multimedia content, i.e. video, being transmitted over the Internet.

Streaming content—multimedia content, including video, that is normally played sequentially. Streamed content typically does not have to be fully downloaded before it can be viewed, but rather can be viewed in real time as it downloads to the user's computer.

Encoding—the process of converting videotape, or other source material to a digital file that can be played on a personal computer. Certain types of encoding will convert source material to streaming content that can then be transmitted over the Internet.

Format—the specific type of multimedia content, e.g.,. Windows Media, Real Player, QuickTime, etc. The same item of streaming content could be available in more than one format. For example if videotape was encoded in Windows Media format, only those users that had the Windows Media plug-in could watch the video.

Plug-in—a module of code that is specific to each format, typically provided by the manufacturer of that format (e.g. Microsoft, Real Networks, Apple Computer, etc.). The plug-in only needs to be downloaded one time and becomes a component of the user's browser. From time to time a plug-in may need to be updated to a newer version.

Content provider—a company or individual that establishes the necessary system required to deliver streaming content to users. A content provider can deliver streaming content in any number of formats but usually specializes in delivering one particular type, e.g. Windows Media.

Player—an interface for playing multimedia content on an area of the screen. The interface typically provides various controls that a user may click on to control the content, e.g. “stop”, “pause”, and “play” buttons.

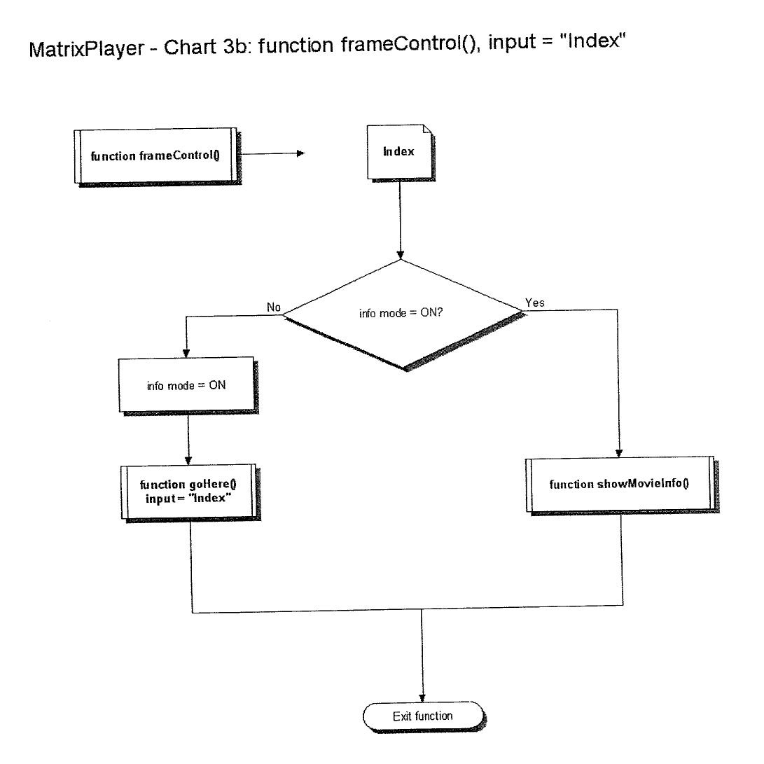

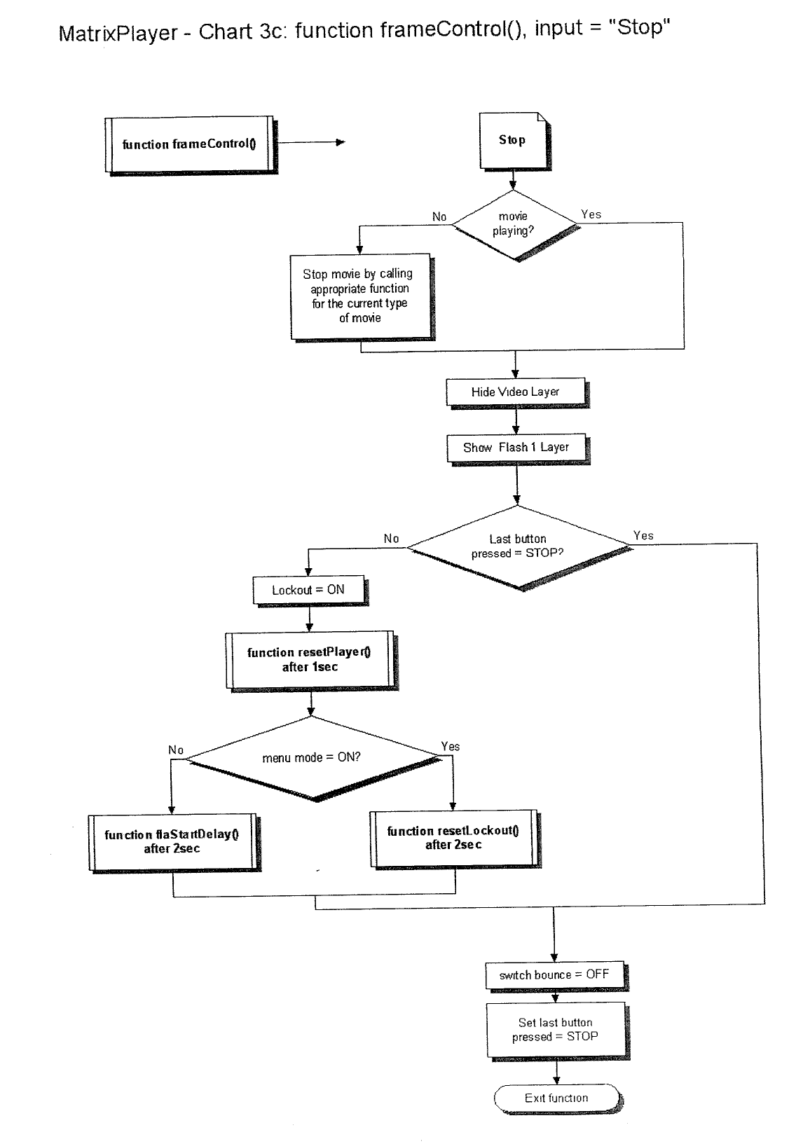

Stand-alone player—A player, typically provided by the manufacturer of the format, which appears in its own separate window and is an application that functions independently from the browser. Each player of this type has its own specific appearance and can typically only play content that is encoded in its own format. (FIG. 3)

Web-based player—a player that is part of a web page or appears in a browser pop-up window.

II. Overview

General Description

The MatrixPlayer is a web-based application that runs in a browser window. It works in either Microsoft Internet Explorer or Netscape Navigator and allows the user to view streaming video content. The same MatrixPlayer delivers content in Windows Media format, Real Player, QuickTime or any newer streaming format that becomes available. While this feature alone separates the MatrixPlayer from other players, there are many other features that make it truly unique.

Before the MatrixPlayer was developed, there were two primary ways to play streaming content. The first involved using the player application provided by Real Networks, Microsoft, or QuickTime. These players appeared in their own window, completely separate from the browser. The second method was simply to embed the video directly into a web page.

The MatrixPlayer starts out as a hybrid of both methods and adds functionality that is lacking in both. A few of the important features of the matrix player are: a fully customizable interface complete with “skins” designed for the particular application, the ability to change the location of the video and interchange it with screens of text in real time as the video plays, and a powerful set of scripting commands allowing the video to fully interact with the user. These and other features are described below.

Overview of Features

1. Multiple Screens

One important feature of the MatrixPlayer is the ability to switch between multiple screens of information that all occupy the same location in the player, while a video is playing. This is the “Matrix” aspect of the player. Most televisions and VCRs made today have a similar capability. When a person is watching a show on TV, they can press a button on their remote and a menu appears on the screen. They can adjust the volume, change other settings on their television, or set their VCR while still listening to their show. The MatrixPlayer has this same capability; it can display alternate screens of information while a video is playing. This saves screen space, allowing the entire player to be smaller, and at the same time greatly improves the appearance of the player by hiding menus and other controls until they are needed. All screens can be independently sized and configured as specified by the content provider through scripting commands. One example would be to simply display a screen filled with a Macromedia Flash animation that plays in the same space where the video plays, whenever a video is not playing.

2. Custom Interface

Using the custom interface features of the MatrixPlayer, content providers can control the “look and feel” of the MatrixPlayer so as to match that of their existing media, whether it's an existing web site or simply a company's color scheme. All of this can be accomplished without any programming experience. Anyone familiar with Adobe Photoshop can build an entire interface for the MatrixPlayer. First, the designer chooses the size that they want the popup window to be. Next, the designer specifies a “skin”. The video as well as the other controls can be placed anywhere in the window. The controls can be any size or shape. Unlike Microsoft's newest stand-alone player, which also has the option to use custom skins, a MatrixPlayer skin can be made that is larger than the popup window and can be interactively moved by the user or even by the video itself. Using scripting commands built into the MatrixPlayer, multiple skins can be designed for the same MatrixPlayer window and different videos can “choose” their own skin. Skins can even be swapped back and forth while a video plays. Further, a content provider can implement an appropriate customization algorithm to dynamically select the skin based on a profile of the particular user (male versus female, age, browsing or purchasing history, etc.)

The MatrixPlayer also provides interaction between Macromedia Flash animations and the regular controls of the player. Using this feature, a designer can create animated controls with complicated rollovers or other effects. An entire skin could be made in Flash and would still be completely independent from another Flash animation used to occupy the space when there is no video playing. Also, Flash animations generally have quicker download times than comparable animated GIFs or static graphics that use JavaScript for animation.

3. Scripting

Scripting works with Windows Media, using its ability to send events that are embedded in a video or audio stream. A command set was developed specifically for the MatrixPlayer that allows the content provider to use the standard Windows Media authoring tools to embed MatrixPlayer commands in a movie's timeline. Captions are received by the MatrixPlayer and are displayed in whatever font and color has been set when the skin was designed. This is just another element that improves the look and feel of the Player. Any HTML may be included with the caption for spot changes to color, style, and font. URLs can also be sent to the MatrixPlayer, which will open a new window with that link.

In addition to captions and URLs, the MatrixPlayer has additional scripting commands that provide a unique authoring environment. For example, a movie can pause itself and present the user with a menu of choices. A movie can move itself to different locations on the player or even outside the player, while the audio track continues to play. Scripting commands can change or move the skin or the captioned text, for interesting special effects. A tweening command allows the video, text, or skin to scroll smoothly from one point to another, over a given period on the timeline. Finally, there are advanced scripting commands for content providers with programming experience. One allows JavaScript commands to be executed directly from the video stream and another will load additional macros to the MatrixPlayer, allowing for future development and expansion of the Player's capabilities, without having to develop a new version of the Player itself.

4. Advertising

The MatrixPlayer has two built-in methods for providing revenue from advertisements. The first is a mechanism to deliver banner ads. The content provider can freely choose the size and location of the banner itself. Banner graphics are placed in a folder and are rotated automatically each time a video is played. Banners can also be grouped according to content and each group can be associated with its corresponding content.

The second method of providing advertising content is through video commercials. These commercials are completely separate videos that are also stored in a designated folder. In the same way that banner ads are rotated, video ads can also be automatically rotated and played at the beginning of a feature clip that a user has selected. There is no interruption between the commercial and the video. When the commercial ends, the video immediately starts with no additional buffering. Video commercials may also be grouped according to content. Also, the number of times a video commercial has been played can be tracked and this information can be reported to advertisers. Banner ads and video commercials may be used individually, simultaneously, or not at all.

These and other unique features of the Player are described in detail below.

III. Description

Multiple Technologies

The MatrixPlayer's makes use of a combination of technologies, including HTML, DHTML, JavaScript, Java, Visual Basic, and Active Server Pages (ASP). When the MatrixPlayer is launched, it determines whether the current browser is Microsoft Internet Explorer or Netscape Navigator. Because of the numerous differences in the two browsers, including differences in the implementation of JavaScript, two versions of the MatrixPlayer are used. The user is never aware of the two different Players because their appearance, feature set, and operation are identical. Both versions of the player share the same set of data files and can play all of the same content.

Plug-ins Load Only as Required

Another important feature of the MatrixPlayer is that plug-ins need not be loaded until they are needed. For example, if the content provider only supplies video in Windows Media format, then the MatrixPlayer will not attempt to load the Real Player plug-in, even though it has the capability of immediately playing Real Player content if it exists. A second example would be the use of a Macromedia Flash animation. If no Flash animations are used, the MatrixPlayer will not query the browser for the plug-in and the Player will operate normally whether the user already has the plug-in or not.

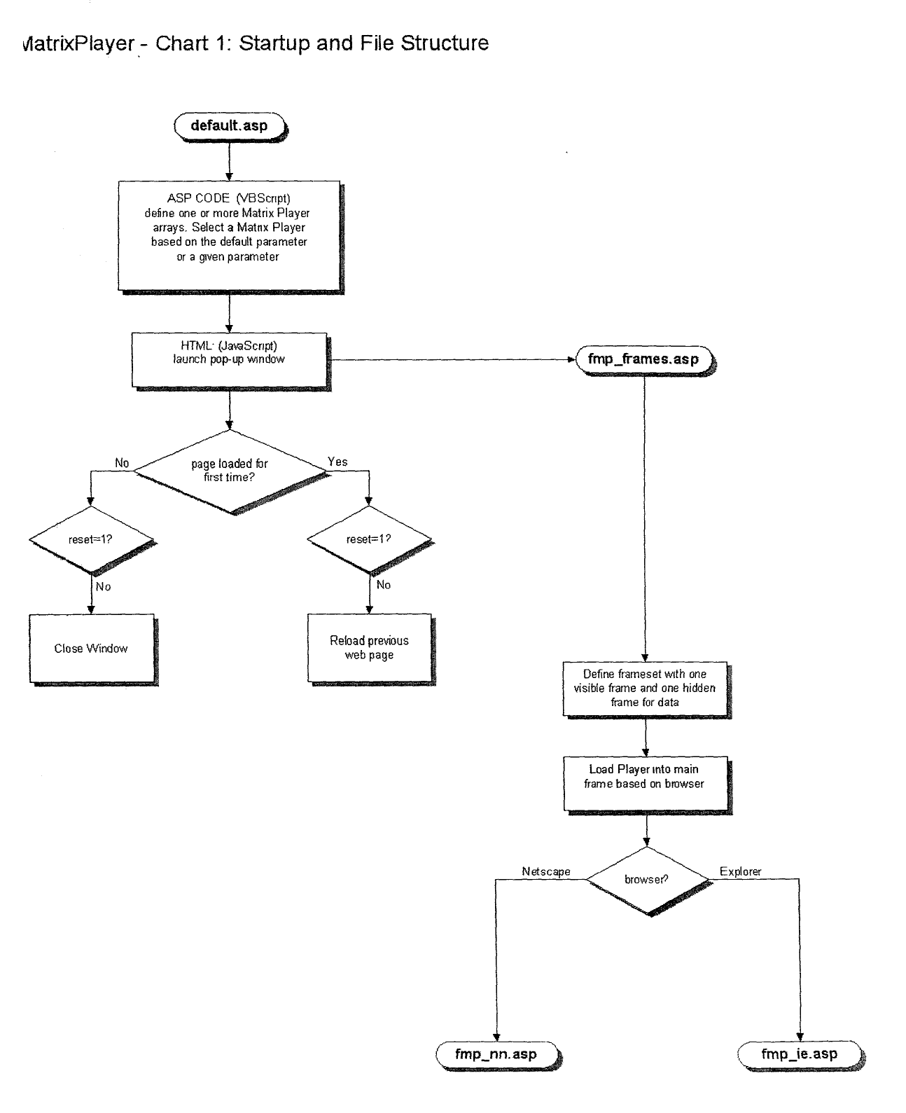

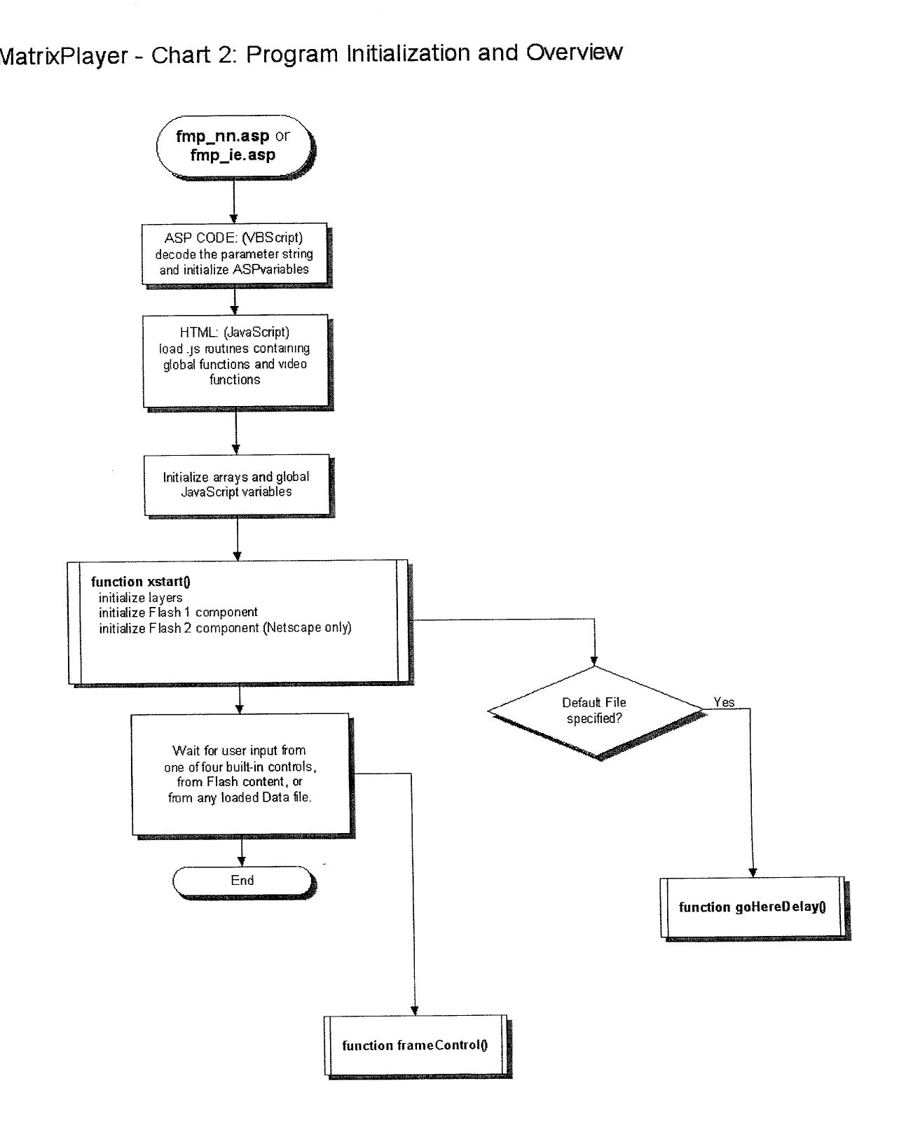

Other browser-based players rely on the use of separate pages. Typically, the user must make a choice whether they have the Windows Media plug-in or the Real Player plug-in, for example. Once the user makes that choice, another web page is loaded accordingly. The MatrixPlayer does not have to load different web pages for different players, and the user is not forced to make a choice. The content provider still has the option of giving the user a choice of players, and if the user has more than one plug-in installed, as is usually the case, they may switch back and forth between plug-ins effortlessly. Unlike other players, the MatrixPlayer can play Windows Media content and Real Player content in the same frame and in a single page (FIGS. 1b, 1c).

On the Macintosh, the Real Player plug-in will load when necessary to play Real Player content. Windows Media content will launch the stand-alone Windows Media Player because Microsoft does not yet support streaming media content that is embedded in a web page, in MacOS. This is expected to change within the next few months.

Multiple Screens

As mentioned above, the MatrixPlayer has the ability to display a menu or any other HTML content at the same time a video is playing, in the same space that the video occupies, without interrupting the video. While this is a completely new concept in streaming media player design, it is also quite a bit more advanced than the on-screen text menus of a television or VCR.

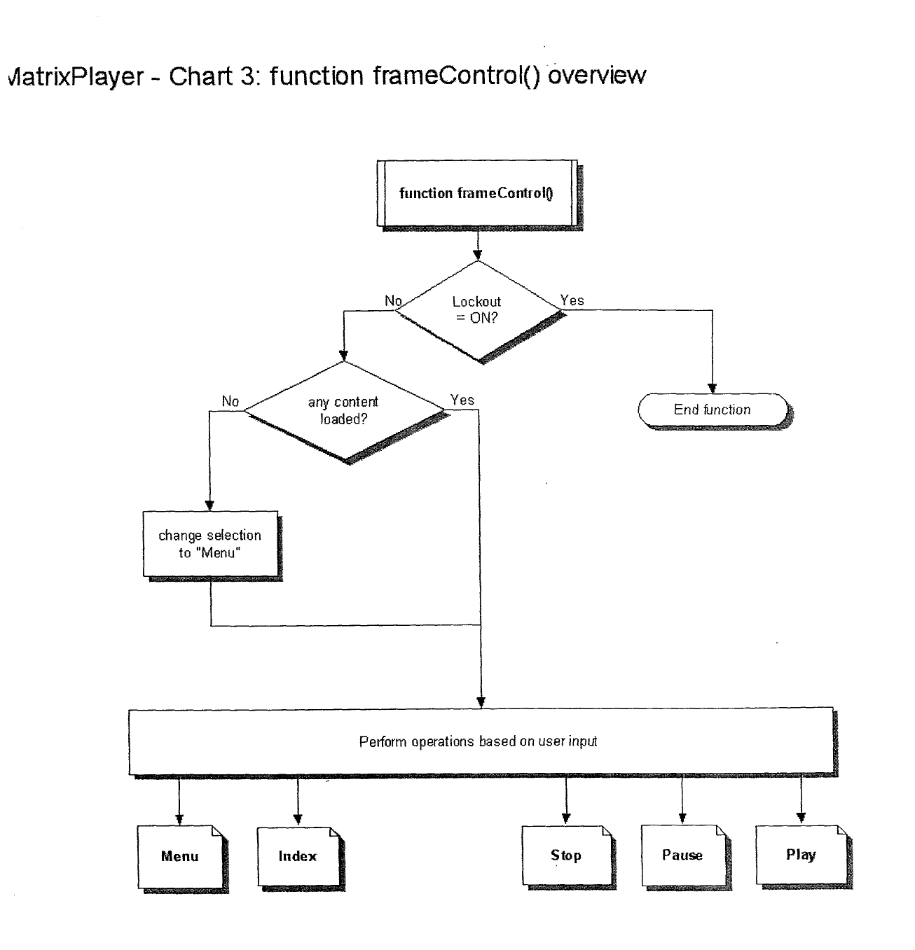

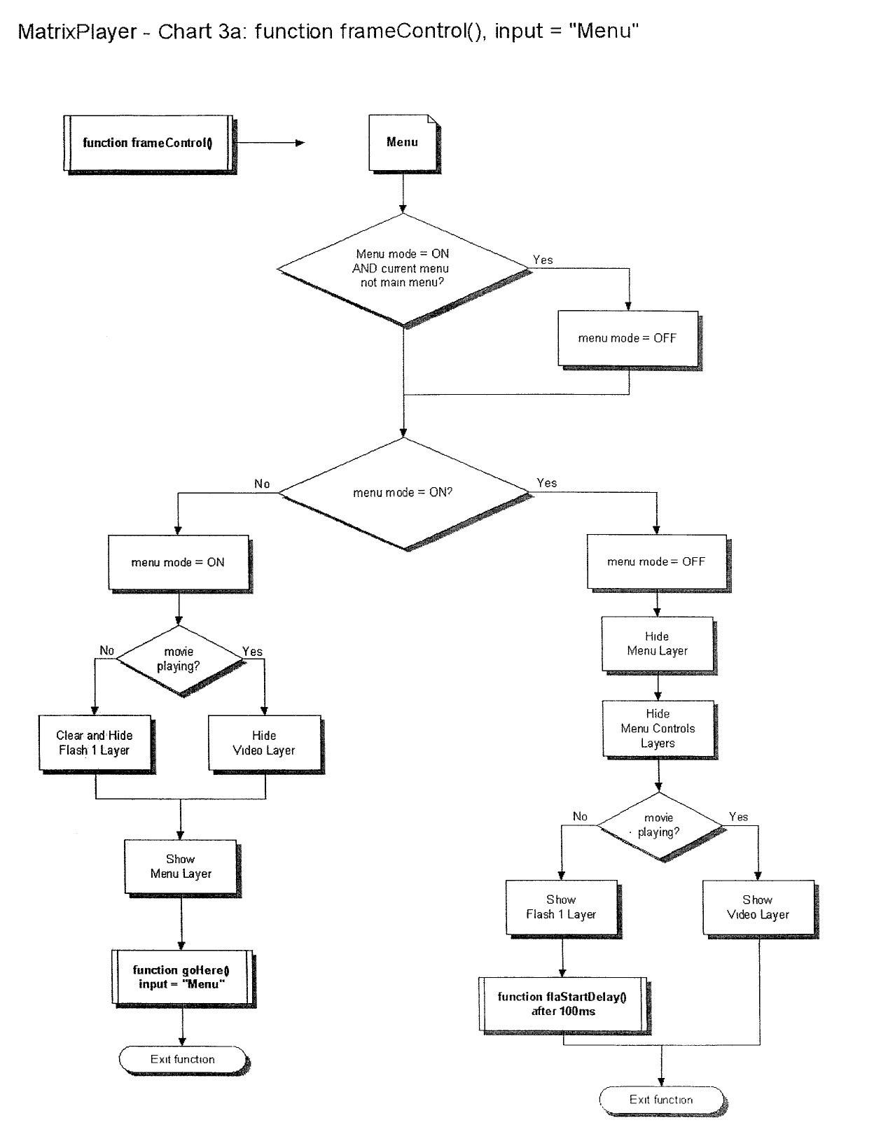

The MatrixPlayer has five built in screens; the video, menu, caption, logo, and animation screens (FIG. 2). All five screens may be independently sized and positioned within the MatrixPlayer window. All screens are components of a single web page as opposed to being in a frameset. Because these components are not constrained by the use of frames, they may be dynamically repositioned at any time and may even overlap or be placed on top of one another.

1. Video Screen

The video screen is simply the area of the MatrixPlayer where video content plays. The video screen can be repositioned at any time through scripting command, independent of the other components. Its size can change for each video that is played, allowing for low or high bandwidth videos to be played in their respective sizes. The video screen can even be moved around the Player while a video is playing, using special MatrixPlayer scripts. A video played with the MatrixPlayer is no longer a static component of a web page. It becomes an interactive component that can move to different locations as the content changes, or could even “bounce” off the walls of the Player.

2. Menu Screen

Normally the menu screen is set to the same size and position as the video screen. This reduces clutter and allows the entire Player itself to be much smaller (FIGS. 1a, 1b). If desired, the menu screen can be made any size and positioned anywhere. Also, the menu screen is not limited to text or text links. It may contain any HTML formatting, images, JavaScript, etc. The menu screen does not have “scroll bars” but instead has an automatic system for navigating between pages. If the content provider designs a menu with many pages, small buttons labeled “Prev” and “Next” will automatically appear at the bottom of the menu screen. On the first page, only the “Next” button is displayed and only the “Prev” button is visible on the last page.

3. Caption Screen

In addition to the menu screen, there is the caption screen. Normally, it contains a textual description of the video but it is also quite useful as an index. Captions sent by streaming media are sent to this screen therefore it is generally positioned just below or to the right of the video screen (FIG. 2). The caption screen provides dynamic text and HTML content that is changed by each video. A user can switch back and forth between a fixed index or other menu and information about the currently loaded video. Caption events sent by the video will override any secondary menu in the caption screen. In contrast, the menu screen provides a menu that is always available, regardless of events sent by the video.

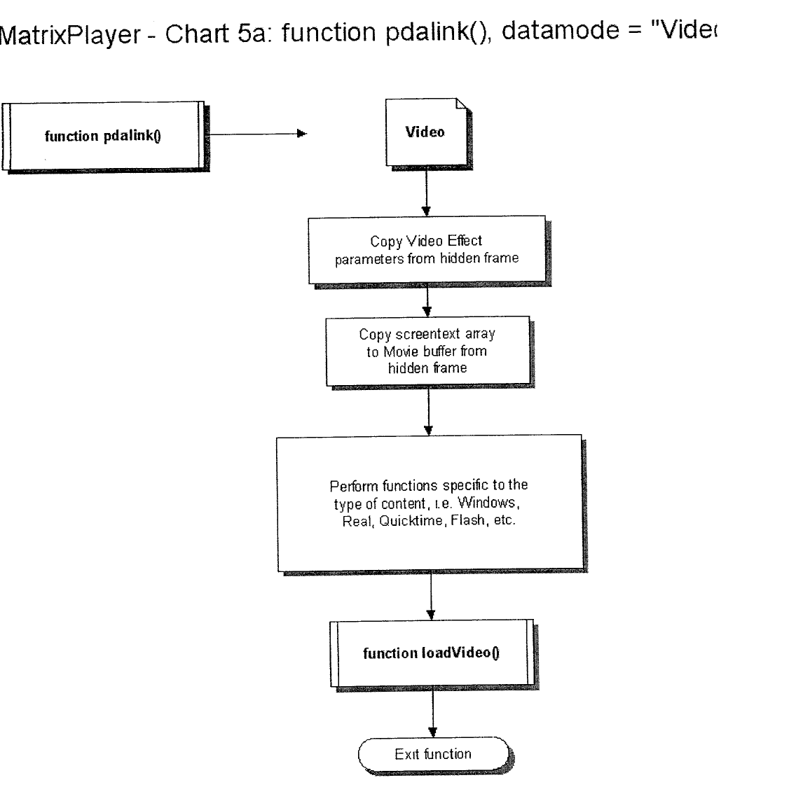

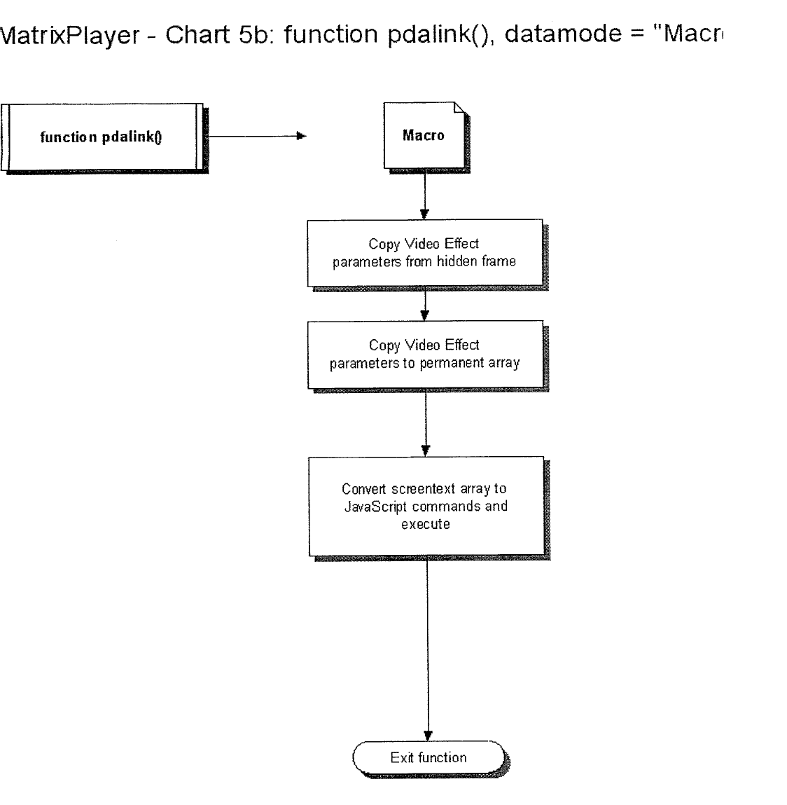

Links in the menu screen can directly load information into the caption screen. Using this functionality, the main menu can have a list of hyperlinked categories. When one of these links is clicked, a list of subcategories is displayed in the caption screen, while the original list of categories remains visible in the menu screen. (FIG. 6b, 6c) In this way, it becomes much easier for a user to navigate through a large database of information without losing track of where they are.

4. Logo Screen

The logo screen automatically appears when there is no video playing and disappears once the user has started a streaming event (FIGS. 2, 6a). The logo screen may contain static GIF or JPEG graphic or may contain a Macromedia Flash animation. If a Flash animation is used, some simple guidelines are followed so that the Flash content does not cause conflicts with streaming media content.

5. Animation Screen

The animation screen is optional and can be used to provide alternate buttons with complicated rollover effects. This screen is designed to use a second Macromedia Flash animation that is completely independent from any other Flash content already in use in the Player. The MatrixPlayer provides an environment in which a Flash animation can control any type of media or any component of the Player itself. Furthermore, Windows Media files can send commands to the MatrixPlayer, which in turn can control the Flash animation or load other animations.

Simple Controls

The MatrixPlayer comes with five built-in controls. They are “Stop”, “Pause”, “Play”, “Menu”, and “Index”. The first three are used to control the video while the last two control the menu screen and caption screens respectively. A single, multi-function “Play/Pause” button can be substituted for separate “Pause” and “Play” buttons, for a total of only four controls (FIG. 2). The “Menu” button swaps the video screen with the menu screen, as they are usually positioned on top of one another. If there are nested menu screens, clicking once will return to the root menu screen and clicking a second time will return to the video screen. The user is never more than two clicks from the video and will still hear the audio track no matter what level of menu is displayed. The “Index” button toggles the caption screen back and forth between the default index page and whatever text field is displayed with the current video choice. A caption sent by a video will always override whatever text is currently displayed in the caption screen.

Customizable Interface

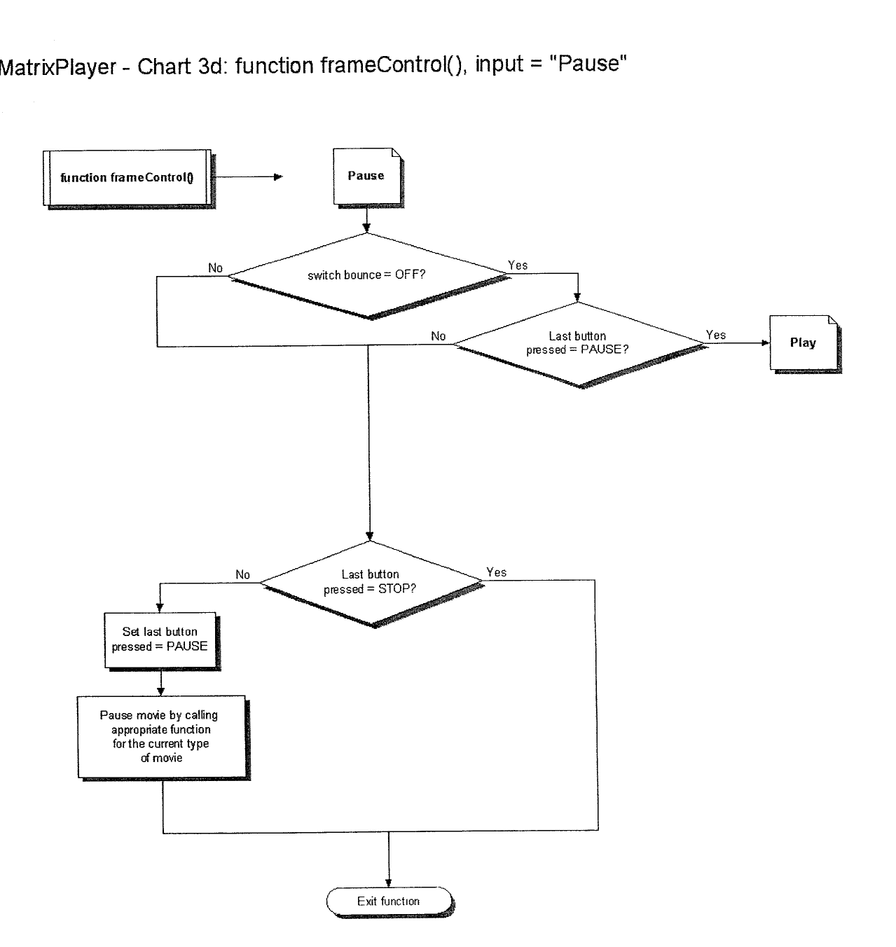

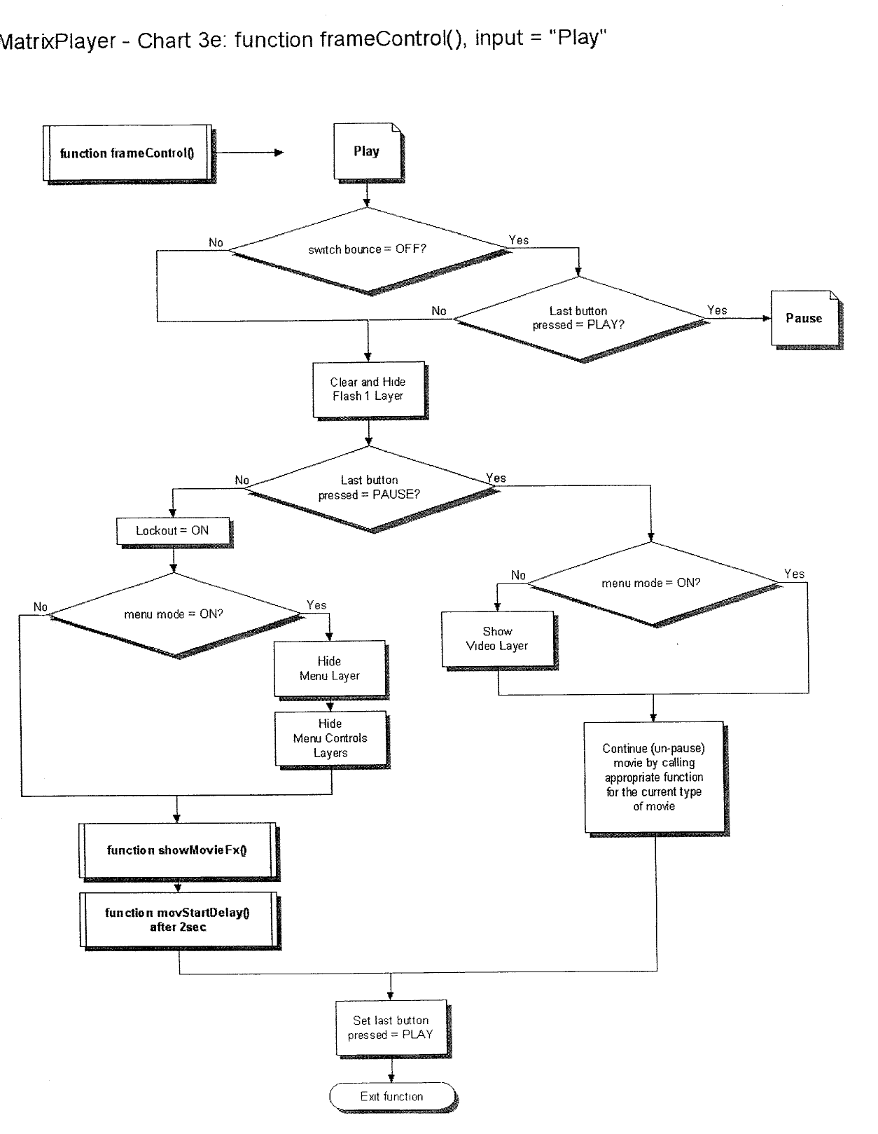

The MatrixPlayer's interface is easy for content providers to customize. The basic components of the MatrixPlayer are five screens (discussed above), five buttons, and a banner ad. The separate “Pause” button, the fifth screen, and the banner are optional. The Matrix skin designer merely decides on the size, shape and placement of these objects and places them all in a single graphic (FIG. 2). This graphic becomes the “skin” of the player and can be saved in either GIF or JPEG format. Because there are no restraints as to size shape or position of either the buttons or screens, a designer can control the appearance of the MatrixPlayer with great flexibility (see, e.g., FIGS. 4, 4b)

The five buttons that are built into the Player are all optional if the designer provides their functionality in the form of a Macromedia Flash animation. This animation is placed in the animation screen and can be located anywhere on the skin. The designer can add rollover effects as well as other animation effects to the buttons as well as to the Player itself. The process of designing a skin is detailed separately below.

The popup window that contains the MatrixPlayer is usually set to the same size as the skin, however this does not have to be the case. For example, the designer could make a skin that is twice as wide as the popup window, then “scroll” the skin back and forth using the scripting commands that are built into the MatrixPlayer.

Data Files

All content within the MatrixPlayer is based on simple, fill-in-the-blank data files. Data files provide fully customizable HTML content, text menus, and an individual template for each piece of content. If so desired, a content provider could change to a different skin each time a different video is played. Data files control the size and location of each video independently. Different videos can be assigned to different areas of the Player for example. Data files also provide the ability to load new plug-ins as they are developed. Macros that change the Player on a per session basis are also available. No programming experience is required to set up Matrix Data files. Creating one is simply a matter of filling in the required fields in any text editor. Using Matrix Data files is detailed separately below.

IV. Implementation Details

Overview

The MatrixPlayer works by managing a number of “layers” within a single HTML page. These layers contain video, text, HTML, graphics, or Flash animations. The layers can be moved on or off screen at any time and can be placed at any location in the HTML page. Through the unique use of layers, the MatrixPlayer is able to play multiple video formats in the same HTML page and without reloading the page each time a format is changed. The MatrixPlayer is able to rotate between a streaming video, a text screen, and a Flash animation in the same physical location on a user's screen, all without interrupting the video that is playing. Because the MatrixPlayer can load and unload plug-ins whenever necessary without reloading the page or loading new pages, it can combine all of the different features provided by each plug-in. Data files are loaded into a hidden frame allowing the Player to have an unlimited number of menus or playlists. Again, because of the way layers are implemented, a single playlist can have can have content from any or all of the different formats. The MatrixPlayer has its own set of scripting commands which allow fully interactive multimedia presentations.

Startup and File Structure (see Chart 1)

When the default.asp page is launched, the ASP code creates a parameter string with roughly 60 parameters, which define all aspects of a particular MatrixPlayer. A single text string is used because the list would be too long to be pass as a list of separate parameters normally passed through ASP.

Normally, parameters are passed by including them at the end of the URL as in the following example:

http://www.tvtaxi.com/mypage.asp?first=Rob&last=Giordano&height=73

Passing a list of 60 parameters would exceed the maximum number of characters that a single URL can contain. The single text string is encoded with a simple Visual Basic routine in the ASP header of default.asp.

Next, default.asp launches a popup window. The MatrixPlayer that has been selected determines the size of this window. The frameset page, fmp_frames.asp is loaded into the popup window and the parameter string is passed to it.

The frameset page determines the user's browser type and loads one of two MatrixPlayers, fmp_nn.asp or fmp_ie.asp into the main frame. The parameter string is passed along to this file. A second, hidden frame is for loading Matrix Data files.

Finally, default.asp reloads the previous page in the browser's history, closes its own window, or does nothing. The functionality of these pages is important because it allows the MatrixPlayer to regenerate itself. If there is a link to the default.asp page in a current MatrixPlayer popup window, another entirely different MatrixPlayer can be loaded from the same small group of files. The default.asp page will launch a second popup window with the new player and then will close its own window, removing the original popup window from the screen.

Program Initialization and Overview (see Chart 2)

When either fmp_nm.asp or fmp_ic.asp is launched, the ASP header decodes the parameter string. The ASP variables are processed on the server and various locations in the JavaScript and HTML sections of the page are filled in with these variables before the page reaches the user's browser.

One of the major differences between the Netscape and Explorer versions of the Player have to do with scripting and how the two Flash layers are parsed as the page initially loads. In the Netscape version, both Flash layers are initialized using DHTML, after the page has loaded. This occurs in the xstart( ) function. Also, both Flash components are embedded using only <EMBED> tags. Cross browser code was not necessary since this particular operation must be handled differently for each browser. Using document.write in the HTML code to embed the second Flash component actually disabled the Java scripting for Windows Media Player. This is important to note because the Explorer version requires the second Flash component to be embedded as the page is parsed by the browser, in order for the FS commands to function.

Initially, FS commands did not work consistently in Netscape. Adding a 20 ms delay to each command solved this problem.

FS commands are specific to Flash and are used to send parameters to a JavaScript function in an HTML page. An easier way to send JavaScript commands from a Flash movie is to use the GetURL command in Flash. This works fine in both Netscape and Explorer, except when a Windows Media Player movie is playing in Explorer. In that particular case, clicking any button in the Flash animation that uses the GetURL command, causes Window Media Player to stop playing the movie because it “sees” a click-through. Using GetURL commands for Netscape and FS commands for Explorer would require two versions of every Flash movie used or it would require the Flash movie to determine the browser type. This would make it much more difficult to author Flash content for the MatrixPlayer, so FS commands were adopted as the standard.

In the Explorer version, the first Flash layer is initialized using DHTML but the second layer is embedded as the page is parsed. The first Flash layer is still initialized with DHTML so that the animation does not start before the page has loaded. In order for FS commands to operate in Explorer, a VBScript routine is used because there is a lack of direct communication between FS commands and JavaScript. As stated above, GetURL commands are the preferred method of communication between Flash and JavaScript but they cannot be used when playing Windows Media content.

The Explorer version uses <OBJECT> tags to embed the first Flash layer. These tags are not actually part of the HTML code but are in a text string that is used with DHTML to embed Flash in a layer after the page has finished loading. There was a problem using this method of embedding in an ASP page. When the ASP code is parsed on the server side, it did not recognize that the <OBJECT> tag was not actually part of the HTML code and generated an error code. This prevented the page from loading. Simply breaking up the string so that the server would not recognize the tag solved this problem. Here is an example of the code:

′<OBJ′+′ECT . . . >′

After the Player has completely loaded and all of the components have been initialized, the Player either waits for user input or it loads a default file if one has been specified. If a file is loaded, the goHereDelay( ) function is called, while user input is directed to the frameControl( ) function.

Function frameControl( ) (see Chart 3)

The frameControl function is responsible for many of the unique aspects of the MatrixPlayer. It receives commands from user input as well as from scripting commands sent by a movie or Flash animation. The five basic commands; “menu”, “index”, “stop”, “pause”, and “play” correspond directly to the visible controls on the Player. This small set of commands allows a very simple user interface while providing a high degree of control of the MatrixPlayer. Each command performs multiple functions that change depending on the current status of the Player.

The frameControl( ) function begins with a “Lockout” control that disables all additional commands until it is reset. This allows certain processes to occur without the user inadvertently interrupting them. For example, a browser may crash if a user starts certain processes multiple times by double clicking instead of single clicking. Also, certain plug-ins require a short delay after they have been deleted. This allows other plug-ins to load properly. The MatrixPlayer's ability to load and unload multiple plug-ins that would ordinarily conflict with one another would be compromised if user input could not be temporarily turned off. The “Lockout” function solves this problem.

Next, a test is made to see if any content has been loaded. If no content is available, a “Stop”, “Pause”, or “Play” command will be diverted to “Menu”.

Clicking once on each of the five controls performs the operations detailed below:

MENU: (see Chart 3a)

(a) If a menu (or other text page) is currently displayed on the Video Screen and it is not the default menu file (db_mainmenu.htm), display the main menu.

(b) If a menu is currently displayed (menu mode=ON), hide the menu layer and show the movie layer if there is a movie playing, or load the Flash 1 animation and show the layer. The Flash 1 animation is loaded after a 100 ms delay to prevent conflict with the sound from a movie that was just stopped.

(c) If no menu is displayed (menu mode=OFF), hide the movie layer if there is a movie playing, or hide the Flash 1 layer and clear the plug-in and show the menu layer.

(d) exit the function.

The logic of the Menu control allows the user to toggle back and forth between a movie and a text menu, without interrupting the movie. If the user clicks on a link in the main menu that displays a sub-menu, the next click of the Menu button will return to the main menu, and a second click returns to the movie. The audio track of the movie continues to play while menus are displayed.

INDEX: (see Chart 3b)

(a) If the text from the currently loaded movie is currently displayed (info mode=OFF), hide the movie text and show the index layer.

(b) If the index layer is currently displayed (info mode=ON), hide the index layer and show the movie text layer, if any.

The logic of the Index control allows the user to toggle back and forth between the text associated with a movie and a secondary text menu. If the user clicks on a link in the main menu or in the secondary menu, the next click of the Index button will return to the secondary menu, and a second click returns to the text associated with a movie.

STOP: (see Chart 3c)

(a) If a movie is playing, the necessary functions are called to stop the movie.

(b) The video layer is hidden and the Flash 1 layer is shown, although it is still empty

(c) If the last button pressed (last command received) was not “STOP” then turn on the Lockout function, reset all changes to the player by the current movie, and load the Flash 1 animation in the Flash 1 layer after 2 seconds if menu mode=OFF. If menu mode=ON, reset the Lockout function after 2 seconds, otherwise the Lockout function is reset when the Flash 1 layer is initialized.

(d) Turn off the switch bounce function and set the last button pressed to “STOP”.

The logic of the Stop control prevents the user from stopping a movie more than once, which can cause errors with certain types of movies such as Windows Media Player. Also, pressing the Stop button activates the Lockout function, which gives the movie time to clear itself from the layer without the user interrupting this process by clicking another button. This is important because the Windows operating system can only give control of sound to one application at a time. Using a Flash 1 animation with sound, the sounds will not play if the animation is started immediately after stopping a movie. Initializing the Flash 1 layer after a 2 second delay solved this problem.

PAUSE: (see Chart 3d)

(a) If “switch bounce” =OFF and the last button pressed (last command received) was “PAUSE”, jump to the “PLAY” control (see Chart 3e).

(b) If the last button pressed (last command received) was not “STOP” then pause any currently playing movie that has the ability to be paused.

PLAY: (see Chart 3e)

(a) If “switch bounce” =OFF and the last button pressed (last command received) was “PLAY”, jump to the “PAUSE” control (see Chart 3d).

(b) Clear and hide Flash 1 layer, if present

(c) If the last button pressed (last command received) was “PAUSE” then show the video layer if menu mode =OFF and un-pause the current movie.

(d) If the last button pressed (last command received) was not “PAUSE” then hide the menu layer and controls if mode =ON, make any changes to the player, and start the movie after a 2 second delay.

The “switch bounce” function is simply a variable that is turned on or off. It is used to simulate a “bounceless switch”. In electronics, bounceless switches are used when the same non-mechanical switch is used for multiple modes, like when a switch is pushed once to turn a device on and the same switch is pushed again to turn the device off. The process of pressing the switch can actually cause the contacts in the switch to connect multiple times within a fraction of a second. This is caused by microscopic “bounces” of the contacts or can happen if the switch is held down for more than a fraction of a second and the state of the switch is read multiple times. Since very few people could actually push a button or click a mouse perfectly every time, a “bounceless switch” introduces a short delay that starts from the time the first switch contact is made. Other contacts of the switch are ignored during the delay period. In the MatrixPlayer, the same button can be used for “PLAY” and “PAUSE”. The user clicks once to play a movie, clicks the same button again to pause it, and clicks a third time to resume play. The “bounceless” feature prevents the user from accidentally clicking the button twice or holding the button down too long. Having a single button to play and pause a movie makes it easier for a user to advance a movie very slowly until a desired frame appears.

The PAUSE control remains a separate control so that it can be called from a script embedded in a movie. This way, a movie can pause itself for a given number of seconds, while another event occurs such as loading another page in a popup window. A movie can also pause itself indefinitely and wait for the user to make additional selections or view an advertisement before continuing.

Function goHere( ) (see Chart 4)

The goHere( ) function loads data files into the hidden frame. The function also uses a Lockout function so that a user cannot attempt to load a second file while one is already loading. The function will attempt to load any file that ends in “.htm” or “.asp”. Any file can be loaded into the hidden frame, which allows for significant expansion of the Player's features. Absolute or relative URLs can be sent to this function as well as two specific commands, “Menu” and “Index”. These two commands load the db_mainmenu.htm and db_index.htm files respectively. These are the two data files that are loaded when the “Menu” and “Index” buttons are clicked, as described in the sections above. Since these files are accessed frequently, they are stored in a buffer after the first time they are loaded. It was discovered that in situations where a narrowband connection was being used, there would be significant delays reloading these two files while a movie was streaming, even though the file existed in the browser's cache. Creating a buffer for these two files solved that problem.

Function pdalink( ) (see Chart 5)

The Player cannot accurately predict when a data file will be finished loading. Most of the time it will be within a second or two, but sometimes, even over a high bandwidth connection, a server will time out for a few seconds or more. If the Player tries to read variables from a data file before it has loaded, errors will result. A timer could be used, but this would cause the user to wait a certain length of time which would normally be unnecessary. Creating a function that is called by the data file itself, once it was fully loaded solved this problem. Once the data file has finished loading, it calls the pdalink( ) function in the Player.

First, the pdalink( ) function determines what type of data file has just been loaded. As of the current version of the MatrixPlayer, there are four types of data files: “Text1”, “Text2”, “Video”, and “Macro”. The function of each data type is detailed below:

Text1—Loads text into the Video screen. Any currently playing movies will continue to play the audio track but the video will be hidden. The new text will appear, along with any HTML formatting or embedded graphics. If the db_mainmenu.htm file is loaded, it is displayed and saved in a buffer. If it is another file, clicking the MENU button will clear this text and load the “Main Menu” file, either from the server or from its buffer. Clicking MENU a second time will display the movie again, if it is still playing.

Text2—Loads text into the Caption screen. If there is a movie currently playing, any text that appeared when the movie first loaded will be hidden. The new text will appear, along with any HTML formatting or embedded graphics. If the db_index.htm file is loaded, it is displayed and saved in a buffer. If it is another file, clicking the INDEX button will clear this text and load the “Index” file, either from the server or from its buffer. Clicking INDEX a second time will display any text associated with a currently loaded movie. If a movie is sending captions to the Player, the captions will overwrite any “Text2” file. In other words, when a “Text2” Data file is loaded, it will remain on screen until a movie sends another caption, the movie ends, the user clicks the INDEX button, or the user clicks another link to a “Text2” Data file.

Video—Loads a movie into the Video screen and text into the Caption screen. It also loads any effects included in the Data file. Each “Video” file has the ability to load its own MatrixPlayer skin, position the skin, select a size for the video, and position some of the other components of the Player. The new text will appear, along with any HTML formatting or embedded graphics. The text associated with a movie is saved in its own buffer so that it can be reloaded without accessing the server again. Whenever a movie is stopped, this text is returned to the screen so a user can always see which video is currently loaded. Also, any effects, such as changes to the Player skin, etc., are reset when the movie is stopped. These effects are also saved in a buffer so that if the movie is played again, the effects do not have to be reloaded from the server again.

Macro—Loads effects into the permanent MatrixPlayer arrays, changing the Player for the rest of the session. Effects included in “Video” Data files are only visible while that particular movie is playing. Sometimes it might be desirable to change the look or functionality of the Player for the rest of a session, or until further changes are made. Also, this file can execute JavaScript commands directly in the Player. Advanced users can create scripts that can control any aspect of the Player, including but not limited to moving controls, changing the functionality of controls, loading different Flash animations, or sending special commands to Flash animations already loaded in the Player. Even though the set of scripting commands is quite powerful, a simple script command embedded in a movie could load a “Macro” Data file, which could then execute an entire list of commands. This file type makes the expandability of the MatrixPlayer almost limitless.

Other Data Files

If a file loaded into the hidden frame does not call the pdalink( ) function, the file does not need any of the other variables, and can be of any file type. This system allows the MatrixPlayer to communicate with other applications that use their own methods of control. As long as the controls for a secondary application can be placed in an .htm, .asp, or other type of file, the MatrixPlayer can use these files to pass information to another application.

Consider the following example of using a non-native data file:

(a) There are two windows on the screen, one is the MatrixPlayer, and the other is an interactive Flash movie.

(b) A user clicks a link in the MatrixPlayer, which loads a file that is not a Matrix Data file but an .asp file created specifically to change several variables in the second window containing the Flash movie.

(c) The file finishes loading but does not call the pdalink( ) function, so the MatrixPlayer takes no action.

(d) The file performs some calculations in JavaScript based on the input variables in the ASP query string and sends this information to the other window that contains the Flash movie.

(e) It is apparent to the user that clicking the link in the MatrixPlayer directly affected the Flash movie in the other window.

Other MatrixPlayer functions

Some of the other functions in the MatrixPlayer, and the problems they solved, will now be described.

xMediaMonitor( )—This function works with Windows Media files and checks every two seconds to see if a movie is still playing. When a Windows Media movie ends, the stream itself stays open until it is physically stopped. This function closes the stream and clears the layer when a movie has ended. In Netscape, an error occurred and caused the browser to crash when the current state of the movie was read with in the way suggested in commonly available documentation. The following line caused Netscape to crash:

if (document.layers[′moval′].document.multiPlayer1)

“multiPlayer1” is the name of the Windows Media embedded object. Using the following code solved this problem:

if (document.layers[′moval′].document.embeds[0])

Sometimes it is difficult to predict what index an object will have when it is not embedded when the page is first parsed by the browser. In this case however, the object will have an embed index of zero since only one object is embedded in that layer at a time.

movstartDelay( ), flaStartDelay( ), goHereDelay( ), loadVideoDelay( )—These functions either call another function immediately or call several functions immediately. These functions are called after a delay using the JavaScript function setTimeout( ). The problem that occurs is that JavaScript does not consistently pass parameters to other functions when using setTimeout( ). Using these functions solves this problem.

changeSkin2( )—This function is provided because of a bug in Netscape on the Macintosh platform. When the skin was updated in the first function, changeSkin, the graphic would not update. Calling this second function after a 20 ms delay solves this problem.

newcontent( )—This function allows the user to load and play a number of different media files from a local hard drive. The plug-in used to play the media file is chosen based on its file extension. On the Macintosh, files must end with a period and a three-letter file extension or they will not be recognized. The form field that sends the URL to this function should exist in a “Text1” Data file because newContent( ) targets the mxmenu layer, which is the layer that “Text1” Data files are loaded into.

convNavPath( )—This function works with the newContent( ) function and modifies URLs chosen by user input so Netscape will understand them. It makes the necessary conversions from forward slashes to backslashes for nested folders and converts the colon after a drive letter to the “|” character. The Macintosh version of Netscape uses “file://” plus the rest of the URL to the local file and must have all non-alphanumeric characters escaped. The Windows version of Netscape uses “file:///” plus the rest of the URL to the local file.

Scripting

In the Netscape version of the Player, script commands are received by a Java applet. This applet should be the first plug-in object to initialize as the browser parses the page. This in itself created problems in the Explorer version, even though Explorer does not require the applet. The applet passes a command name and a parameter to the OnDSScriptCommandEvt( ) function. Once there, the script commands are processed and executed. Also, because the Windows Media plug-in is unloaded and reloaded into a layer each time it is used, the Java applet should be initialized each time a Windows Media file is played. This is done in the global .js routines.

In the Explorer version, script commands are received by a separate section of JavaScript code that directly processes and executes them. This JavaScript section of code is set up as an event instead of a regular function.

In both versions, small delays of up to 1.0 sec are sometimes needed for certain scripts to execute properly. This is especially true for commands that change the contents of any layer. Commands that simply move layers to new positions require no delay.

Setting Up

The MatrixPlayer requires a folder on the Server side containing the following items:

| | |
|---|---|
| Subfolders: | |
| images folder | contains skins and other images |
| animations folder | contains Flash animations |
| data folder | contains Matrix Data files |
| Files: | |
| blank.htm | temp page for frameset placeholder |
| captioning.class | Java, necessary for Netscape scripting |
| default.asp | contains parameters for the Player |
| fmp_frames.asp | frameset for popup window |
| fmp_ie.asp | MatrixPlayer, Internet Explorer version |
| fmp_nn.asp | MatrixPlayer, Netscape version |
| genx2.asp | dynamically generates .ASX files |
| globfunc.js | Global JavaScript functions |
| readme.txt | notes for current version |
| vidspecs.js | Video control JavaScript functions |

The items in this folder are portable, meaning that the MatrixPlayer can be run from any web site, hard drive, network drive, or CD-ROM. (Because the MatrixPlayer uses ASP technology, the Microsoft Personal Web Server, Microsoft FrontPage, or equivalent server extensions should be installed in order for the MatrixPlayer to run locally.) The content itself has to be tailored for the specific application but there could easily be two identical MatrixPlayers in the same folder where one pulls content from a web server while the other pulls content from a local drive.

Designing a Skin

The first step to implementing the MatrixPlayer is designing a “skin”. The skin is simply a single .JPG or .GIF graphic that fills the MatrixPlayer popup window. The design of the skin determines the overall size of the Player and its entire look and feel. A single MatrixPlayer may have multiple skins. In addition, multiple MatrixPlayers can be created, each with its own size, shape, or design. The following are some basic guidelines to follow when designing a skin for one specific commercial implementation of the MatrixPlayer.

FILE TYPES: The skin is a single .JPG or .GIF graphic that fills the window of the player.

SIZES: The overall size of the player should not exceed 640×480 but can be as small as 320×380 or 500×240 depending on how the required components are arranged.

VIDEO SCREEN: There should be a 320×240 space where video will play. This space can be located anywhere on the player. It does not have to be blank but text and links will float in this area when a video is not playing so any pattern should be light enough or dark enough so the text will be readable. The text and link colors can be chosen to go with the skin.

CAPTION SCREEN: There should be either a 230×140 or 180×240 space for a captioning area. These are minimum dimensions and may be increased as desired. This space can be located anywhere on the player but must not overlap the video screen. If desired, the two screens can be right up against each other and made to look like one screen. Again, there will be text floating on top so any design in this area should allow the text to be readable.

CONTROLS: There are 4 controls: “Stop”, “Pause/Play”, “Video screen”, and “Caption screen”. They can be drawn any shape or size and can be located anywhere on the player. Obviously they should not overlap either of the screens. The buttons do not have to be labeled in any particular way although icons are preferred instead of text labels. The “Stop” and “Pause/Play” buttons should use the standard icons that most people are familiar with. The two other buttons control the functionality of the two screens. Each one should somehow indicate which screen it controls.

ANIMATED CONTROLS: Instead of drawing controls on the skin, a small Macromedia Flash movie can be placed anywhere on the player as long as it does not overlap the two screens. The four controls can be created in Flash and can thus have animated rollover effects. Buttons may NOT have sound effects. Any combination of regular controls and Flash controls can also exist. For example, the “Stop” and “Pause/Play” controls could be made in Flash while the other two controls could be drawn on the skin.

VIDEO SCREEN ANIMATION or GRAPHIC: When there is no video playing there is an optional Flash animation or graphic that occupies the same space as the movie. Sound is allowed in this animation. The animation can loop continuously or can just come to a stop. It will be replayed from the beginning each time a video comes to an end. Static graphics should be either .JPG or .GIF files and will appear as soon as a video has come to a stop. There is no need to worry about colors here because the animation or graphic disappears before any text appears.

CREDIT: In the bottom right-hand corner of the player, draw a very small icon or logo. This will be a button that gives credit to the artist that designs the skin. Next, make a .JPG or .GIF that is 200×125. When someone clicks on the corner of the Player, a little pop-up window will appear, filled with this graphic. The graphic will not link to anywhere.

Installing a Skin

Once a skin has been created, the next step is to describe the skin and the Player itself with a list of parameters. Open the file default.asp in a text editor or HTML editor and at the beginning of the file will be a list of parameters that should be filled in. The Player comes configured with the first Player given an ID number of “100”. This can be changed to any ID number desired. Additional MatrixPlayers can be defined by copying and pasting the parameters list and assigning unique Player ID numbers.

The first section defines the colors of the text and links in the Player. Regular HTML hex color codes are used. For example, “#ffffff” is white and “#000000” is black:

| | |
|---|---|
| dtxt=“#333333” | ′Text color |
| dtxl=“#097089” | ′Links color |
| dtxv=“#097089” | ′Visited Links color |
| dtxa=“#0990aa” | ′Active Links color |
| dtxb=“#7eb026” | ′Background color |

The next section gives overall information about the Player. Separate sizes are listed for the skin and the popup window: (Normally, the popup window is set to the same size as the graphic but having separate sizes opens up further possibilities. For example, a skin could be made that is twice as wide as the popup window. This large skin could slide to the left or to the right, revealing two different looks with one skin.)

| | |
|---|---|
| popx=640 | ′Width of the popup window, in pixels |
| popy=480 | ′Height of the popup window, in pixels |
| skinx=640 | ′Width of the skin graphic, in pixels |
| skiny=480 | ′Height of the skin graphic, in pixels |

The next section contains the paths to the additional graphics and folders used by the Player. These path names may be relative to the current folder or they may be complete “http” links that point to other servers:

| | |
|---|---|
| skinfile=“images/fmpskins/fmpskin200.jpg” | ′path to the skin graphic |
| xflash1=“animations/bigfmp200.swf” | ′path to the first optional |
| | Flash animation |
| xflash2=“animations/fmp200.swf” | ′path to the second optional |
| | Flash animation |
| datapath=“tvdata/” | ′path to the data folder for |
| | this Player |
| bannerfile=“” | ′path to optional list of |
| | banner ads |
| adfile=“” | ′path to optional list of |
| | video ads |

The last section defines all of the clickable areas on the Player. The four parameters are in pixels and are based on a coordinate system where the top left corner is 0,0. The parameters are x,y,width,height where x,y is the top left corner of the clickable area. Please note that this is different from HTML image maps, which use top left and bottom right corners to define an area.

| | |
|---|---|
| wp=Array(252,66,320,240) | ′Video (width and height are normally |
| | 320,240) |
| wt1=Array(250,70,324,232) | ′Video text screen (usually the same as |
| | Video) |
| wt2=Array(268,325,228,138) | ′Captions text screen |
| wf1=Array(242,65,339,242) | ′Flash 1 animation (optional) |
| wf2=Array(91,153,105,217) | ′Flash 2 animation (optional) |
| b1=Array(7,443,14,26) | ′Video screen button |
| b2=Array(27,443,14,26) | ′Caption screen button |
| b3=Array(58,443,14,26) | ′Stop button |
| b4=Array(−100,100,20,20) | ′Pause button (optional separate pause |
| | control) |
| b5=Array(78,443,14,26) | ′Play button |
| bnx=Array(0,0,0,0) | ′Banner ad (optional) |

Working with Matrix Data Files

Each MatrixPlayer has a data folder assigned to it. The Path to this data folder was assigned in the last section. This folder contains Matrix Data files, which are small HTML files that provide content for the Player. There are 4 files that come with the folder. The first two, db_mainmenu.htm and db_index.htm are required and should not be renamed. These files are loaded when the Video Screen or Caption Screen buttons are clicked. The third file, db_blank.htm is a template that can be renamed and duplicated to create more data files. The fourth file, vidlist_blank.htm is a template for creating a rotating list of video ads.

Data Fields:

var datamode=“ ”

Enter the appropriate term from the choices provided:

“text1” loads text and/or HTML into the Video Screen.

“text2” loads text and/or HTML into the Caption Screen.

“video” plays a video or other streaming content

“macro” loads additional functions into the Player

var xvideo=“ ”

Used only with datamode=“video”. The path to a video or other streaming content.

Example: “mms://mms.tvtaxi.com/corp/Vito/Vito-high.asf”

var xtype=“ ”

Used only with datamode=“video”. The type of content being played:

“a”=Windows Media: .asf, .asx, .wma, (.mp3,..wav, .aif, .avi, .mpg on Windows platform)

“b”=Real Player: .rm

“c”=QuickTime: .mov

“f”=Flash: .swf

“p” =Plug-in: Used to add other plug-ins on-the-fly

var banList=“ ”

The path to the banner ad list file. This file does not have to be located in the Data Folder. Also, it can be dynamically generated by a database. Leave blank if no banner ads are used.

var vidList=“ ”

The path to the video ad list file. This file does not have to be located in the Data Folder. As with banner ads, it can be dynamically generated by a database. Leave blank if no video ads are used.

///// Preload Graphics/////

This section is used to preload graphics into the browser's cache before a video is played. This helps on a narrow band connection because if images are still loading while a video is streaming, the quality of the video will suffer. If a new skin is used with a particular piece of content or if there are graphics inserted into the text area, the path to each graphic should be inserted as follows:

temp 1.src=“http://www.mywebsite.com/images/mypic.jpg”

If more than 3 images are used, simply add more lines of code and increment the number of the objects, for example:

temp4=new Image( )

temp4.src=“ ”

/////Temporary changes to Player/////

In this section, it is possible to move components of the Player for a particular piece of content. Once the content has finished playing, the components will return to their original positions. Also, the video can be resized. For example, if the MatrixPlayer is set up to play 320×240 videos but one particular video is 160×120 and the large black border that would normally present is not desired, the video can be resized to 160×120 for just that video. The smaller video will be located in the upper left corner of the space where the larger video would normally play. To overcome this, it can also be repositioned or centered for a more pleasing effect.

| | |
|---|---|
| var spos=new Array(0,0) | //Skin position |
| var mpos=new Array(0,0) | //Video Screen position |
| var tpos=new Array(0,0) | //Caption Screen position |
| var vpos=new Array(0,0) | //Video position |
| var vsiz=new Array(0,0) | //Video Size |
| var fpos=new Array(0,0) | //Flash 2 position |

The default setting for fields in this section is 0,0. This indicates “no change”. For this reason, 0,0 should not be used as an actual position. Using a small offset such as 1,0 or 1,1 is barely noticeable yet overcomes this problem.

var newSkin=“ ”

Entering the URL to a .JPG or .GIF graphic in the newSkin field will change the skin of the player. If the image is not the same size as the original skin, it will be stretched to fit. All clickable areas of the skin will remain in their original positions. The URL for a new skin should also be included in the “Preload Graphics” section so that the graphic will finish loading before the streaming media starts.

var skinAuthor=“ ”

This field can be left blank or it can be the URL to a 200×125 ..JPG or .GIF graphic that names the author of the skin. This graphic appears in a small popup window when a user clicks on the bottom left corner of the skin.

CONTENT:

As described above, the first three types of Data are “Text 1”, “Text 2”, and “Video”. The first two will display text or other HTML content in either of the two screens. The third type will play a video and display text or HTML content. This section explains how to create the text or HTML content for Matrix Data files.

var screentitle=“ ”

The title of the Streaming video or other content goes here and will appear in bold at the top of the Caption Screen. This field is optional and may be left blank.

The text or HTML content of each Matrix Data file is contained in the screentext( ) array. For “Video” data files, content in this array is optional but it is usually desirable to have some information about the currently playing content. There may be a time when a data file loads and links contained in it load other videos. In that situation, it may not be necessary to include any text in each of the video data files since text is already being displayed.

Each element of the array represents one “page” of information on the Caption screen. There can be a total of eight pages per Data file. Navigation between these pages in handled automatically by generating small “Prev” and “Next” buttons as needed. Word wrap is automatic but there is no check to see if the text has run out of the Caption screen area. A designer should tailor the content on each page to fit whatever size Caption Screen has been chosen.

a) Entering text into the Array:

screentext[1]=‘This video is about my cat, Fluffy!!!!<br><br>She\'s really, really cute!!!’

Notice that any normal HTML tags are accepted but that internal single quotes or apostrophes ['] and forward slashes [/] must be preceded by the backslash [\] character. Also each additional line of text must be enclosed in single quotes and the line above must end with a plus character [+].

b) Multiple lines of text in the Same Array Element:

screentext[1]=‘This is a video about my cat, <b>Fluffy!!!<\/b><br><br>’+

‘She\'s really, really cute and she loves to eat <em>PhatCat<\/em>brand cat food.’

In this example, the first line ends with a plus character [+]. Notice that the last line must NOT end with a plus character or the file will not load.

c) Linking to Another Data File:

screentext[1 ]=″+

‘<a href=“#” onClick=“goHere(\‘db_faq.htm\’)”>FAQ page<\/a><br>’+

‘<a href=“#” onClick=“goHere(\‘db_video.htm\’)”>Video streaming<\/a><br>’+

‘<a href=“#” onClick=“goHere(\‘db_demo.htm\’)”>Flash movies<\/a><br>’

Here is a Data page that has the datamode set to “Text 1”. It loads into the Video Screen and presents the user with a menu of choices. Notice that it is identical to regular HTML except that all apostrophes ['] and forward slashes [/] are escaped with a backslash [\].

d) Linking to Another Web Page:

screentext[1]=″+

‘Here is a link to my <br>’+

‘<a href=“http://www.gallery215.com/portfolio/”target=“fmp_new”>Portfolio<\/a>’

Links to other web pages will appear in another browser window. If target=“fmp_new” is used, each new link will appear in the same popup window, replacing the page that was there previously. If it is desired that each link spawn its own window, then simply use the command target=“new”.

NOTE: Backslashes inside of URLs do not have to be escaped

e) Using an Image with a Link:

screentext[1 ]=″+

<a href=“#” onClick=“goHere(\‘db_data34.htm\’)”>'+

‘<img src=“http://www.tvtaxi.com/images/go.gif”border=“0”><\/a>’

When using images in a Data File that plays video, it is best to preload the images before the video starts. As mentioned in a previous section, this is accomplished by including the URL to each image in the “preload” section. This way, on a low bandwidth connection, a video will not be interrupted by graphics that are still loading.

NOTE: Backslashes inside of URLs do not have to be escaped

f)Linking to Another Skin:

screentext[1]=″+

‘<a href=“#” onClick=“changeSkin(\‘pda_data/skins/fmpskin13.gif\’)”>Stucco<\/a><br>’+

‘<a href=“#” onClick=“changeSkin(\‘pda data/skins/fmpskin17.gif\’)”>Mahogony<\/a><br>’+

‘<a href=“#” onClick=“changeSkin(\‘pda_data/skins/fmpskin20.gif\’)”>Plywood<\/a><br>’+

‘<a href=“#” onClick=“changeSkin(\‘pda_data/skins/fmpskin40.gif\’)”>Metal<\/a><br>’

These are links to various skins that a user can try out. This is not be confused with using the newskin field which changes the skin of the Player automatically as soon as the Data file loads. Also, there is no need to preload any of the graphics in this example because no graphics are loaded until the user clicks one of the links.

g) Linking to another MatrixPlayer:

screentext[1]=″+

‘<a href=“#” onClick=“changeMatrix(\‘200\’)”>TvTaxi Matrix<\/a><br>’+

‘<a href=“#” onClick=“changeMatrix(\‘120\’)”>Credit Card Size<\/a><br>’+

‘<a href=“#” onClick=“changeMatrix(\‘115\’)”>Gray Circuits<\/a><br>’+

‘<a href=“#” onClick=“changeMatrix(\‘122\’)”>Home Stereo<\/a><br>’

Clicking on one of these links would close the current MatrixPlayer and its window and open a new window for a completely different MatrixPlayer. The number of the MatrixPlayer is the one used in the initial section of default.asp where each MatrixPlayer is defined. Any number of MatrixPlayers can be defined in default.asp and any number can be assigned to each one as long as it's unique.

Launching the MatrixPlayer

Launching the MatrixPlayer may be done in several ways, using optional parameters. The examples below are for a fictitious website, Users1st.com. Userslst.com has designed 2 different MatrixPlayer skins. The first one is for Headline News and the second one is for Entertainment and Sports News. The Headline News Player has been given the code 2001 and is set as the default Player. The Entertainment News Player has been given the code 2002. (The URLs given below are for illustrative purposes only)

DEFAULT LAUNCH:

<a href=“http://www.users1st.com/newsplayer/”>

The MatrixPlayer folder has been named newsplayer and the default.asp page starts automatically. Whatever page is currently displayed in the user's browser will return after the MatrixPlayer popup window appears. This way, the user never leaves the current site when they click on a link to the MatrixPlayer.

Specific Player Launch:

<a href=“http://www.users1 st.com/newsplayer/default.asp?matrix=2002”>

This link launches the Entertainment News Player, which is not the default MatrixPlayer. When a specific MatrixPlayer is specified, the MatrixPlayer will attempt to close the window that launches it. If this is the original browser window, a dialog box will appear asking the user if they want to close the window. This might be a little confusing so a better way to do this is to use the noreset parameter:

<a href=“http://www.users1st.com/newsplayer/default.asp?matrix=2002&noreset=1”>

Specific Movie Launch:

<a href=“http ://www.users1st.com/newsplayer/default.asp?file=db_news01 .htm”>

This link launches the default MatrixPlayer and automatically displays the file db_news01.htm. If this Data file contains a video, the video will start playing as soon as the Player has finished loading.

Specific Player And Movie Launch:

<a href=“http://www.users1st.com/newsplayer/default.asp?matrix=2002&file=db_news01.htm”>

Both optional parameters may be used in combination to launch a specific MatrixPlayer and automatically play a specific piece of content as soon as the player loads.

Scripting

Microsoft provides a free and easy-to-use little program called the ASF Indexer. It can be used to embed scripting commands in any Windows Media ASF file. The MatrixPlayer takes advantage of this technology, although other types of indexers or editors could be used in other implementations. The following chart is a list of the specific scripting commands that are built into the MatrixPlayer. These commands only work with the MatrixPlayer and are entered into the “Type” and “Parameter” fields in the ASF Indexer exactly as shown below. These commands will also work with any other type of streaming media that supports embedding commands in the stream, such as Flash movies.

| TYPE | PARAMETER | DESCRIPTION |
|---|---|---|
| skin | skins/pdaskin46.jpg | Loads a new skin on the current MatrixPlayer |
| spos | 12,−35 | Positions the skin. Use positions outside the |
| | | window to make it disappear. The default |
| | | position is always 0,0 |
| text2* | <br><center>Hello!!!</center> | Standard Caption event for text box 2. Any html |
| | &nbsp; | can be used, with NO escape codes. Use the |
| | | second example to clear the screen. |
| page2* | db_newstuff.htm | Loads a MatrixPlayer data page into text box 2. |
| | | Data pages have complete control over the |
| | | Player and can launch other movies, pause the |
| | | current movie, preload graphics, launch other |
| | | windows, load Flash content, etc. |
| tpos | 10,15 | Positions text box 2. Use positions outside the |
| | mt2[0],mt2[1] | window to make it disappear. Use the second |
| | | example to return to default position. |
| mpos | 200,mt1[1] | Positions text box 1. Normally there is no need |
| | mt1[0],mt1[1] | to re-position text box 1 because it is the main |
| | | menu and swaps back and forth with the video. |
| | | For a particular application, however, the user |
| | | may want to make the main menu available |
| | | without covering the video. Use the second |
| | | example to return to default position. |
| vstop | 3 | Stops the video in n seconds |
| vpause | 5 | Pauses the video in n seconds. Use “0” to pause |
| | | indefinitely. |
| vpos | 15,120 | Positions the video. Use positions outside the |
| | | window to make it disappear. Use the second |
| | mp[0],mp[1] | example to return to default position. |
| popup | http://www.yahoo.com | Pops up a full size browser window with the |
| | | specified link. |
| cmdf | xLayerPos(′moval′,10,15,−1,1) | Execute a JavaScript command. This can be used |
| | | to call JavaScript functions in the player or |
| | | additional functions embedded in a |
| | | MatrixPlayer data file. Do NOT call any |
| | | functions that modify a layer. |
| tween | ′text′,20,25,50,260,3.5 | Moves a component of from point A to point B |
| | | in n seconds. The first parameter is ′text′, ′skin′, |
| | | or ′video′. The following parameters are |
| | | x1,y1,x2,y2,secs. Seconds will be roughly |
| | | accurate to tenths only. |

*There is a 1 second delay for this command to prevent dhtml/applet conflicts in Netscape. Jump ahead at least 2 seconds in the movie timeline before placing another scripting command, otherwise both commands will be executed simultaneously and an error may occur.

### V. EXAMPLES

The following are examples of uses for the MatrixPlayer. Because of the large number of variables that the content provider has control of, the possibilities for the MatrixPlayer are almost endless.

1. Simple Playlist—The Player appears with a custom skin and a playlist. The user selects a piece of content from the playlist by clicking on one of the links. The playlist disappears and in its place, the selected movie appears. Text information about the movie appears underneath it. While the movie is playing, the user clicks on the “menu” button and the playlist reappears, replacing the movie. The soundtrack from the movie continues without any interruption while the user navigates the playlist. After looking down the playlist, the user clicks the “menu” button once again and the playlist once again disappears to reveal the movie that has been playing all along.

2. Video Commercials—A user navigates through a playlist of videos. When one is selected, a video commercial begins playing. Once the commercial has finished, the video starts immediately and seamlessly. Once the video is over, the user selects another video which is preceded by another video commercial. Later, the user plays the first video again, but this time it is preceded by a different video commercial than the one that played the first time. So far, the user has only watched two videos but has seen three different 15 or 30 second video commercials.

3. Interactive Shopping—A user watches a video of a runway fashion show. Each time a model reaches the end of the runway, the video pauses itself and the items of clothing that the model is wearing are displayed in the MatrixPlayer, on the right-hand side of the video. The user is given a chance to click on any of the clothing items, which will pop up another window allowing the user to make an online purchase. At any time, the user can simply press “play” and the video will continue. When the next runway model pauses for the cameras, the video pauses itself again to present the user with more choices.

4. Interactive Education—A MatrixPlayer appears with a playlist of training videos. The skin has been designed with a large area for text. The user selects one of the videos and as it plays, text is displayed underneath the video to reinforce the lesson being taught. As the instructor talks to the student through the video, diagrams and charts are displayed underneath the video whenever necessary. The caption screen of the MatrixPlayer becomes a virtual “chalkboard”. At various points during the lesson, the video pauses itself to prevent the user with multiple-choice questions in the form of clickable links. The link that the user clicks on actually determines which segment of the video is played next.

5. Multimedia Presentation—A user selects an item from a MatrixPlayer playlist. The skin disappears and the entire MatrixPlayer goes black. Titles fade in and out as part of a Macromedia Flash animation. A video starts in the left part of the screen while text about the current presentation appears on the right. As the video plays, it slides to the right-hand side of the MatrixPlayer and new text appears on the left. Even though the video itself is low-bandwidth and plays in a small portion of the MatrixPlayer window, the presentation appears to the user as taking up the entire window. When the presentation is over, the MatrixPlayer returns to its original state with its original skin and controls.

The inventive aspects of the Player are further described in the following features comparison chart.

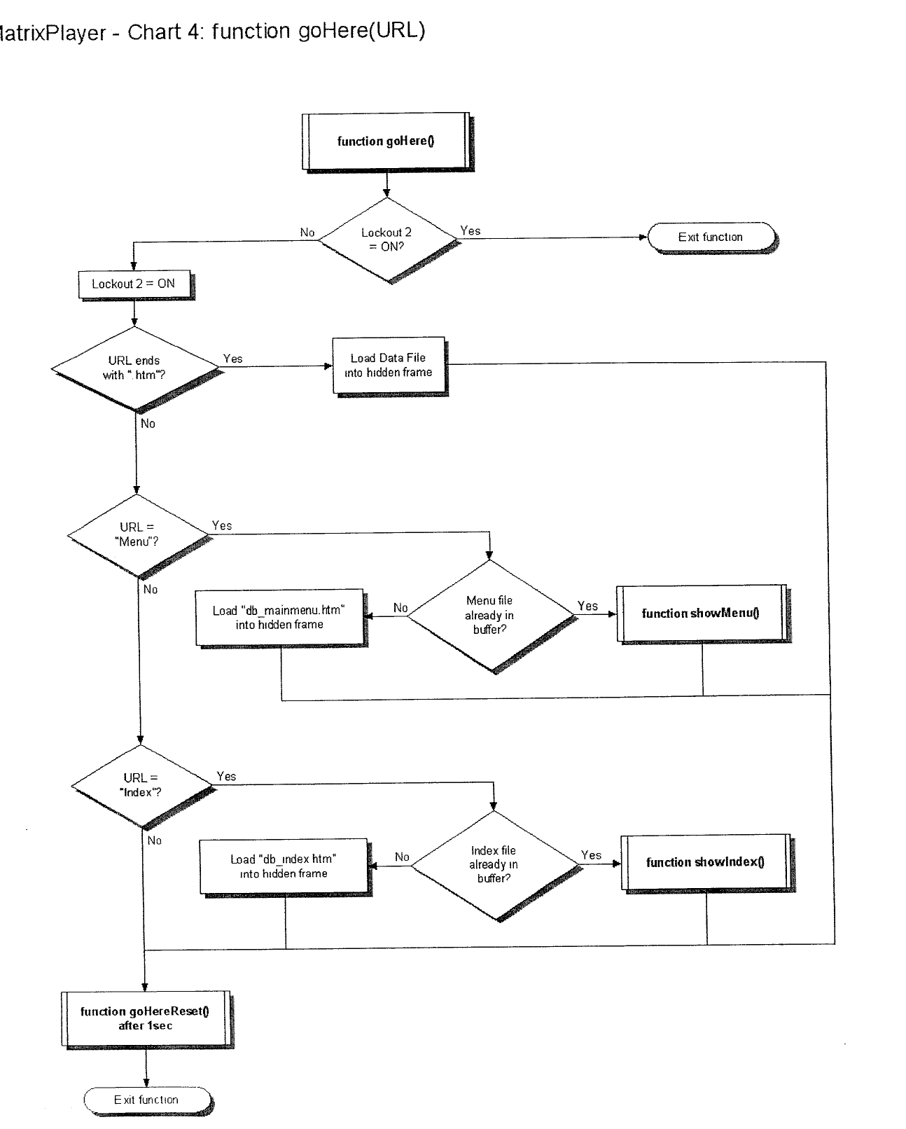

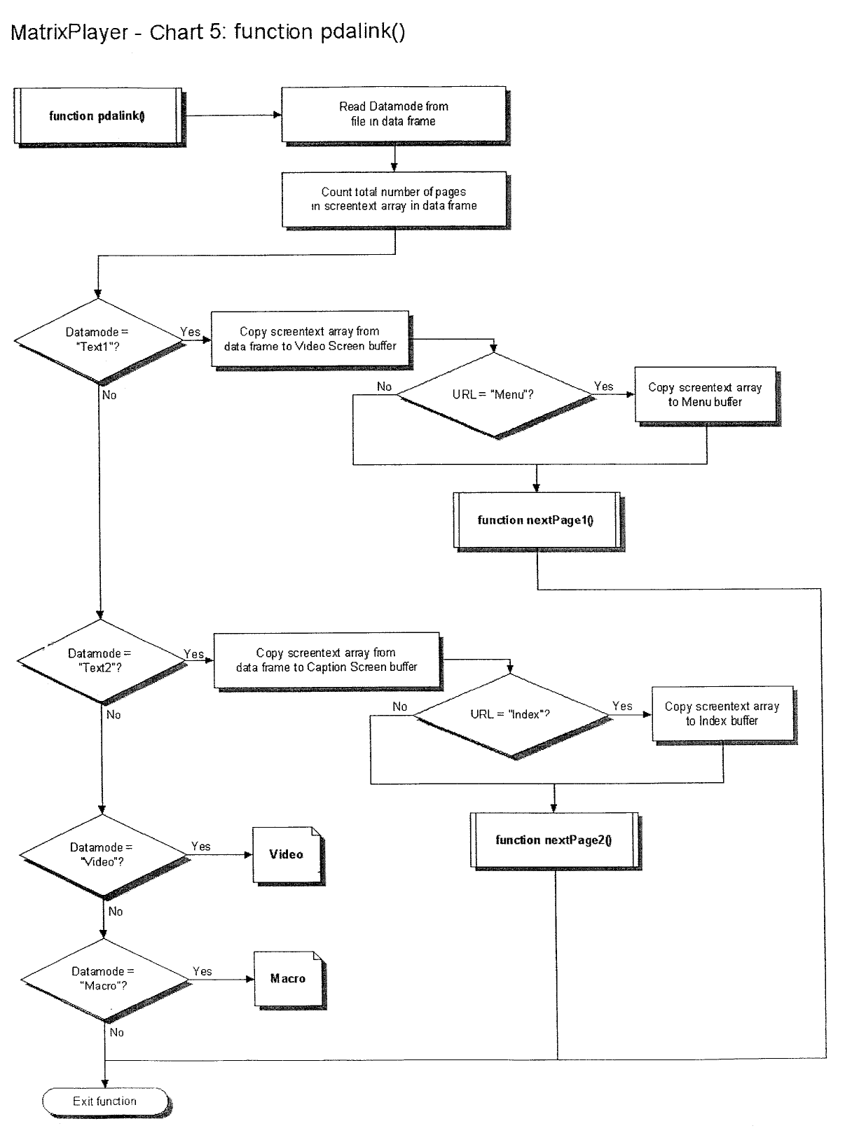

Features Comparison Chart

| MatrixPlayer | Existing Technology | Advantages of MatrixPlayer |
|---|---|---|
| The MatrixPlayer is a web-based | Current web-based players typically | (1) The user need not make as many selections |
| player that can play multiple | either (1) ask the user to select which | before playing content. On CNN's web site, |
| formats in a single web page. All | plug-in they have installed and then | for example, the user clicks on a link to a |
| content can be selected from a | loads one of several separate web | video, a pop-up window appears, then the user |
| single list, regardless of format | pages based on the user's choice, or | is forced to choose a type of format, then |
| (FIG. 1a). For example, if a user | (2) display an HTML frameset of 2 | another page loads. |
| clicks on a link to a video that uses | or more web pages in which one | (2) Plug-ins are automatically loaded one-at-a- |
| the Windows Media format, it will | frame is reloaded with the | time, as they are needed. There is no need for |
| start playing immediately (FIG. 1b). | appropriate web page for the type of | users to select the formats they want to watch. |
| If the user decides to click on | format selected. | The user can simply select a link from a list of |
| another video that uses the Real | | content, which can be in any format. |
| Player format, the first video will | | For these reasons, existing players are either |
| stop and the second one will start | | harder to use, do not provide as wide a choice |
| up in its place, without having to | | of content, or both. |
| load a different page (FIG. 1c). | | |
| The MatrixPlayer provides a | Each web-based player is designed | Web-based players are usually custom tailored |
| customizable user interface where | for the specific web site it serves. A | pages that require a certain level of |
| the content provider can easily | few of the user interface items are | programming ability. The entire look and feel |
| change components. The | available on existing stand-alone | of the MatrixPlayer can be changed without |
| components of the player are (FIG. | players, but generally, stand-alone | any programming skills. Any component of |
| 2): | players (FIG. 3) are cluttered with | the MatrixPlayer can easily be set to any size |
| (1) Skin | controls that most users will not use. | and placed in any location within its window. |
| (2) Controls | | This lets the content provider easily change |
| (3) Video Screen | | the interface of the MatrixPlayer to match the |
| (4) Menu Screen | | content. This aspect of the MatrixPlayer saves |
| (5) Caption Screen | | the content provider time and money while |
| (6) Logo Screen | | providing an interface to the user that is |
| (7) Animation Screen | | integral with the content and is easier to use |
| (8) Scripting | | with than existing players. |
| Each component will be examined | | |
| in detail below: | | |
| (1) Skin component - The | As far as video players are | While the skin on the Microsoft stand-alone |
| overall appearance of the | concerned, only the newest Microsoft | player defines a particular player, skins for the |
| player. Usually a single | stand-alone player has the ability to | MatrixPlayer can become an interactive |
| JPEG or GIF image, the | change the skin of the player. There | element of a presentation. The MatrixPlayer |
| skin could be a simple, solid | are other types of stand-alone players | skin can be changed at any time, even while a |
| colored rectangle or an | that have skins. There are thousands | movie is playing (FIG. 4b). Also, a |
| intricate 3-D texture. The | of skins for MP3 players like | MatrixPlayer skin can be made any size, |
| skin also defines the overall | Winamp or Sonique. Web sites like | independent of the physical size of the player. |
| size and shape of the player | www.skinz.org (FIG. 5) contain | This feature can be used for additional visual |
| (FIG. 4). | collections of skins for practically | effects that are integral with the content. For |
| | every type of player for which | example, a skin could be made that is twice as |
| | changing the skin is an option. | wide as the physical player and then scrolled |
| | | back and forth in synchronization with key |
| | | points in a movie. |
| (2) Controls component - | Stand-alone players as well as web- | The MatrixPlayer uses 4 or 5 built-in controls |
| the graphic buttons that a | based players generally offer basic | consisting of a “stop” button with “pause” and |
| user clicks to initiate various | control buttons, namely “stop”, | “play” buttons or “pause/play” button to |
| functions. | “pause”, and “play”. Some players | control a video. “Menu” and “index” buttons |
| | offer additional controls for volume, | control the two built-in text screens. The same |
| | muting, etc. (FIG. 3). The controls are | “stop” and “pause/play” buttons work for any |
| | specific to the format being played, | format selected. Instead of using a separate |
| | i.e. Windows Media, Real Player, | “pause” button, using the MatrixPlayer's |
| | etc. | “pause/play” button is simpler and provides |
| | | greater control of video playback. A user |
| | | clicks once to begin play, clicks again to |
| | | pause, and clicks again to resume. By clicking |
| | | once first to pause a video, then repeatedly |
| | | double-clicking the “pause/play” button, a |
| | | user can advance a video frame by frame. |
| | | Additional controls can be dynamically added |
| | | using a MatrixPlayer Macro file or by adding |
| | | a control to the Animation component. |
| (3) Video Screen - the | The video in stand-alone players can | The MatrixPlayer implements the video as a |
| rectangular area of the | usually be set to one of several sizes | separate component of the player. With this |
| player where the streaming | but cannot be dynamically | functionality, the video can be instantly |
| content plays. | repositioned within the player. In | moved to any location inside the player. This |
| | web-based players, the player is | can be done while a video plays, without |
| | either built into a page or is part of a | interrupting the video (FIG. 6e). For example, |
| | page within an HTML frameset and | the location of a video could be keyed to |
| | cannot be moved. In either case, the | several different spots depending on the scene. |
| | video is not a separate component | Each video can be assigned its own specific |
| | that can interact with other | location on the screen through its database |
| | components of the player. | file. Through the use of MatrixPlayer |
| | | Scripting, a video can scroll itself from one |
| | | area of the player to another within a given |
| | | length of time, all without affecting a video |
| | | that is playing (FIG. 6f). This adds to the total |
| | | interactivity of a presentation. |
| (4) Menu Screen - a screen | Most modern television | The MatrixPlayer offers a menu screen that appears on top |
| area of menu selections that | sets as well as VCRs | of a video while it is playing. This saves screen space and |
| appears and disappears | offer “on-screen | simplifies the overall look and feel of the player. Having |
| when a button is clicked. | programming” in which | the menu appear only when needed creates an interface that |
| | a screen of menu | is simpler, less distracting, and more visually appealing |
| | selections appears on | than other methods. |
| | top of whatever | Additional Features: |
| | program is playing. | (1) If the menu screen has more than one page of |
| | | information, small “Prev” and “Next” arrow buttons appear |
| | | at the bottom of the menu screen area. On the first page, |
| | | only the “Next”arrow appears and on the last page, only the |
| | | “Prev” button appears. |
| | | (2) If a user has navigated through multiple levels of a |
| | | menu, clicking the menu button once returns to the root |
| | | menu and clicking it again returns to the video. The user is |
| | | never more than two clicks away from the video. |
| | | (3) If a movie is playing, it is not affected or interrupted by |
| | | the menu screen. A user will continue to hear the audio |
| | | track while the menu is displayed. |
| | | (4) The menu screen does not have to be the same size or |
| | | located in the same position as the video although only one |
| | | can be visible at a time. For example, the menu screen |
| | | could be twice as large as the video and could be centered |
| | | over top of it. |
| (6) Logo Screen - a static | Most stand-alone | The MatrixPlayer has a component that automatically |
| graphic or Flash animation | players display the logo | replaces a piece of streaming content once it has finished |
| that appears automatically | of that player's | playing or is stopped (FIG. 6a). This is usually used to |
| whenever a movie is not | manufacturer when a | display the content provider's logo. |
| playing or the menu screen | video is not playing. | Normally, the Logo screen is set to the same size as the |
| is not selected. | However, it is usually | video and is placed in the same location, but this |
| | only static graphic and | component shares the qualities of the other components and |
| | is not a separate | may be designed to be any size and made be located at any |
| | component that can | position. Unlike some of the other components, the Logo |
| | interact with other | screen is not designed to be moved while a video is playing; |
| | components of the | however, a custom macro may be designed to accomplish |
| | player. | this if desired. |
| | | Using Flash, sound or music can be added to an animation |
| | | in the Logo screen. The MatrixPlayer has been designed to |
| | | automatically stop any sound and animation present in the |
| | | Logo screen whenever any streaming media has started. |
| | | This prevents conflicts between Flash animations |
| | | containing sound and the audio tracks of streaming media |
| | | files. |
| (7) Animation | Some web based players use | This component has many uses. It gives the content |
| Screen - a separate, | Flash for animated introductions | provider the power to freely expand the features of the |
| optional component | and others use Flash to actually | MatrixPlayer using Flash. It might simply contain an |
| that contains a Flash | control the streaming content. | animated banner ad or it could be used to provide |
| animation. | This is a fixed element of the | additional interface controls. It may be used to |
| | player and is not a separate | completely replace the standard controls that come with |
| | component that can interact with | the MatrixPlayer. Using the animation features of Flash, |
| | other components of the player. | controls could have intricate rollover effects or drop- |
| | | down menus. A volume control where the user clicks and |
| | | drags the control itself is possible. The Animation screen |
| | | can be as large as desired but must not overlap the Video |
| | | Screen. Also, the Animation screen has the ability to |
| | | communicate with any other function or component of |
| | | the MatrixPlayer through JavaScript commands. |
| | | Note: Since the Animation screen is active at all times, |
| | | sound may not be used in the Flash animation due to |
| | | conflicts with the audio tracks of streaming media files. |
| (8) Scripting | Microsoft has demonstrated the | The MatrixPlayer does not use any of the commands built |
| component - not a | ability to embed commands in a | into the Windows Media Player but instead has its own |
| visual component of | video stream. They provide a | specific set of commands. These commands allow a |
| the MatrixPlayer but | free application, “ASF Indexer” | currently playing video to control any other component or |
| one that allows the | which allows a content provider | function of the Player. Commands can move or animate |
| other components to | to place commands anywhere in | other components, load other web pages, control Flash |
| communicate to each | the timeline of their video. Flash | animations, and even pause the video to allow the user to |
| other. | movies also use a timeline where | make a selection. Because of this, the MatrixPlayer can |
| | commands can be sent to a web | provide a fully interactive experience. A full list of the |
| | page via JavaScript. These | available scripting commands appears in the sections |
| | commands are used to | above. No programming experience or recoding of the |
| | synchronize other events such as | Player is required to use scripting commands. This gives |
| | loading images or other web | any content provider the ability to script fully interactive |
| | pages with specific points in the | multimedia presentations. |
| | presentation. Each time a | |
| | presentation is made that uses | |
| | scripting, an entire process is | |
| | started from scratch and a | |
| | custom web page is constructed | |
| | to handle the different methods | |
| | of receiving script commands in | |
| | different browsers. | |

What is claimed is:

1. A method of providing a web-based multimedia presentation on a remote user computer, comprising:
transmitting to the user computer a web page for display by a web browser, the web page including a player module for displaying a multimedia presentation, the player module providing at least first and second display screens that are provided as respective layers within the web page;
transmitting video content to the user computer for display as a video within the first display screen; and
transmitting non-video content to the user computer for display within the second display screen;
wherein the video content includes embedded commands, including commands which cause the player module to switch the first and second display screens into and out of view within the web page during playing of the video.

2. The method as in claim 1, wherein the first and second display screens occupy the same display area within the web page.

3. The method as in claim 2, wherein the non-video content includes a hypertextual menu which is superimposed over the video content during playing of the video.

4. The method as in claim 1, wherein the video content further includes a command which causes the video to pause itself.

5. The method as in claim 4, wherein the video content further includes a command for causing non-video content to be displayed within a third display screen of the player module with the video is paused.

6. The method as in claim 5, wherein the non-video content displayed within the third display screen comprises an interactive advertisement which is related to the video.

7. The method as in claim 1, wherein the video content further includes commands that specify screen positions of the first and second display screens.

8. The method as in claim 1, wherein the video content further includes a command that specifies a player skin to be displayed within the web page in conjunction with the video.

9. The method as in claim 1, wherein the video content further includes a command for moving at least one of the first and second display screens within the web page during playing of the video.

10. The method as in claim 9, wherein the command specifies a time period and path over which a display screen is to be moved incrementally.

11. The method as in claim 1, wherein the player module loads browser plug-ins as needed based on the format of the video content.

12. The method as in claim 1, wherein the player module includes at least the following display screens, each of which is controllable by commands embedded within the video content: a video screen, a menu screen, and a caption screen.

13. The method as in claim 12, wherein the player module further includes at least a logo screen and an animation screen that are controllable by commands embedded within the video content.

14. The method as in claim 1, wherein the player is capable of playing multiple videos of different formats within the same web page using different plug-ins.

15. A method of providing a web-based multimedia presentation on a remote user computer, comprising:
transmitting streamed content to the user computer for display within a first display screen of the web page; and
transmitting video content to the user computer for display within a second display screen of the web page, wherein the video content includes embedded commands which control the display of the non-video content within the first display screen in synchronization with playing of the video content within the second display screen.

16. The method as in claim 15, wherein the first and second display screens occupy the same display area within the web page.

17. The method as in claim 16, wherein the non-video content includes a hypertextual menu which is superimposed over the video content during playing of the video.

18. The method as in claim 15, wherein the video content further includes a command which causes the video to pause itself.

19. The method as in claim 18, wherein the video content further includes a command for causing non-video content to be displayed within a display screen of the player module with the video is paused.

20. The method as in claim 19, wherein the non-video content displayed with the video paused comprises an interactive advertisement which is related to the video.

21. The method as in claim 15, wherein the video content further includes commands that specify screen positions of the first and second display screens.

22. The method as in claim 15, wherein the video content further includes a command that specifies a player skin to be displayed within the web page in conjunction with the video.

23. The method as in claim 15, wherein the video content further includes a command for moving at least one of the first and second display screens within the web page during playing of the video.

24. The method as in claim 23, wherein the command specifies a time period and path over which a display screen is to be moved incrementally.

25. A web page for displaying multimedia content, the web page comprising:
a first layer which provides a first display screen for displaying a first type of content;
a second layer which provides a second display screen for displaying a second type of content; and
a player module which manages at least the visibility of, and the display of content within, the first and second display screens in response to commands embedded within streamed content.

26. The web page as in claim 25, wherein the streamed content comprises video content.

27. The web page as in claim 25, wherein the streamed content comprises at least one of a music file and an animation file.

28. The web page as in claim 25, wherein the player module modifies locations of at least one of the first and second display screens within the web page based on commands embedded within the streamed content.

29. The web page as in claim 25, wherein the player module loads browser plug-ins as needed based on the format of the streamed content.

30. The web page as in claim 25, wherein the player module includes at least the following display screens, each of which is controllable by commands embedded within the streamed content: a video screen, a menu screen, and a caption screen.

31. The web page as in claim 30, wherein the player module further includes at least a logo screen and an animation screen that are controllable by commands embedded within the streamed content.

32. The web page as in claim 25, wherein the player module is capable of playing multiple videos of different formats within the web page using different plug-ins.

33. A web-based multimedia presentation, comprising:
video content having at least one pause command embedded therein, the video content adapted to be played as a video; and
a web page comprising a web-based player module which is adapted to play the video file, wherein the player module is responsive to the pause command by pausing play the video.

34. The web-based multimedia presentation as in claim 33, wherein the video file further comprises a command for displaying an advertisement upon pausing of the video.

35. The web-based multimedia presentation as in claim 34, wherein the advertisement is for a product displayed within the video.
